(19) United States
(12) Patent Application Publication
(10) Pub. No.: US 2015/0279366 A1
(43) Pub. Date: Oct. 1, 2015

(54) VOICE DRIVEN OPERATING SYSTEM FOR INTERFACING WITH ELECTRONIC DEVICES: SYSTEM, METHOD, AND ARCHITECTURE

(71) Applicant: Cubic Robotics, Inc., Palo Alto, CA (US)

(72) Inventors: Konstantin Krestnikov, Moscow (RU); Yuri Burov, Mountain View, CA (US); Nadia Shalaby, Cambridge, MA (US); Andrej Grjaznov, Moscow (RU)

(21) Appl. No.: 14/673,673

(22) Filed: Mar. 30, 2015

(30) Foreign Application Priority Data
Mar. 28, 2014 (RU) 2014111971

(51) Int. Cl. G10L 15/26; G10L 17/22

(52) U.S. Cl. CPC G10L 15/26; G10L 17/22

(57) ABSTRACT

A system comprising an electronic device, a means for the electronic device to receive input text, a means to generate a response wherein the means to generate the response is a software architecture organized in the form of a stack of functional elements. These functional elements comprise an operating system kernel whose blocks and elements are dedicated to natural language processing, a dedicated programming language specifically for developing programs to run on the operating system, and one or more natural language processing applications developed employing the dedicated programming language, wherein the one or more natural language processing applications may run in parallel. Moreover, one or more of these natural language processing applications employ an emotional overlay.

### CROSS-REFERENCE TO RELATED APPLICATIONS

This application claims priority to and the benefit of co-pending Russian Federation utility patent application, METHOD AND SYSTEM OF VOICE INTERFACE, Serial No. 2014111971, filed 2014 Mar. 28, which is incorporated herein by reference in its entirety.

### FIELD OF THE INVENTION

This disclosure relates to the field of human-computer interaction using a Natural Language Processing (NLP) engine to process spoken interaction between a human in his natural language and an electronic device, in which the electronic device is expected to “understand” the human's intent and participate in ongoing discourse. Such discourse may comprise a simple answer, or describe the result of a web search or other analysis. Such discourse may also lead to actions, such as commands sent to devices connected directly to an electronic device or through a network. Example applications exist in many areas, such as the fields of entertainment, calling centers, automatic control in industrial factories and assembly plants, vehicle control, as well as in the Internet of Things. More specifically, this disclosure relates to systems, system architectures, and methods for building a voice interfaces and voice controlled applications to carry out the interaction between an electronic device and a human user. Additionally, this disclosure relates to building computer programming environments and tools for system developers to design and implement such voice interfaces.

### BACKGROUND OF THE INVENTION

Natural Language Processing plays an ever-increasing role in human-computer interactions, and is now an expected feature of many mobile devices.

During the advent of Artificial Intelligence (AI) research in the 1960s, NLP tasks focused on foundational problems such as co-reference resolution, discourse analysis, morphological segmentation, natural language generation, natural language understanding, part-of-speech tagging, parsing, question answering, relationship extraction, topic segmentation and recognition, and word sense disambiguation. The systems did not become viable, and development continued very slowly until personal computers came into widespread use.

Up until the 1980s, most NLP approaches were based on complex sets of hand-written rules. This was based on AI systems emphasizing semantically oriented, and expressly represented rule based approaches. However, by the early 1990s, partly due to the increasing computing power and memory capacity, an NLP revolution ensued using statistical machine learning approaches, which make soft, probabilistic decisions based on attaching real-valued weights to the features making up the input data. Such approaches were particularly successful in Speech Recognition (speech-to-text), natural language translation, and text-to-speech generation. These systems are now doing an excellent job with the mechanics of speech recognition and are now commonly deployed as relatively isolated add-on programs associated with mobile phones, telephone response systems, computers and the like.

Despite these advances, true human-like interaction between a user and an electronic device continues to be very substantially restricted in the domains that they address, are limited to primitive cliched language structures, and are frustratingly prone to error unless operated within simple bounds. Example modern-day systems include Siri, Cortana, Google Now, Speak-to-it, Amazon Echo, Robin, and Go dog. These systems are the subjects of many jokes and parodies because of their common limitation to single question and answer situations (a “single-transaction” restriction), known brittleness and competence in limited subject matter areas.

At the same time, the rapid development of the mobile Internet and the Internet of Things (IoT) are resulting in an exponential growth of user applications and interfaces, offering real-time services. In as much as each of these well-known systems above can drive a few applications, such as dialing a phone, these systems offer a hint of the potential for driving user applications and computer interfaces through voice commands. The present systems do not provide a broad based platform capable of supporting the range and depth of applications needed in everyday life. Consequently, there is an unmet need for a competent and implementable approach that could offer a uniform and ubiquitous natural-language driven interface to a heterogeneous set of devices which are seamlessly functional across the variety of environments that a user must traverse in everyday life or work. In short, the presently available systems are point applications that cannot be practicably integrated with other devices, services or programs that exist external to the device on the NLP system is running.

There have been proposals in the art to provide a voice control layer to various kinds of applications, and to provide those tools to developers. These services were generally envisioned to provide developers with a rudimentary and pre-set API of Natural Language Processing functions. However, to date, these popular systems have provided developers tools for building systems where the NLP component can provide only a single answer to the user's single question (i.e., a context independent single-transaction model) in one iteration. Present systems developed with these application specific tools have been widely adopted, even though the systems can usually provide only that functionality that can be accommodated with one turn interactions or even single interactions within one topic. Many assistants can't answer any additional questions related to an initial query at all. This means that when a user wants his topic changed, it is as if the entire conversation (if such interaction can be called a proper conversation) starts over from scratch. Such systems can be classified as “One iteration assistants.”

Systems such as Google Now and Siri are not completely restricted to this model, and can sometimes answer one additional question dedicated to the topic of the previous request. For example “Who is Barak Obama?” . . . “Who is his wife?” Such systems can be classified as “Two iteration assistants.”

However, no one assistant known in the market can switch back to a previous topic after an initial query on a different topic.

Many situations and systems in the real world require a dialog (as in the dialog between the human and the device) history dependent decision tree to solve a user's problem. In other words, many applications require follow-on questions that vary depending on previous answers. In effect, something more like a conversation or ongoing dialog is needed, rather than simply giving the computer a context independent command or having the ability to ask a single clarifying question. Because existing systems do not solve the context problem and provide the ability to build applications with a conversational interface, these current systems do not provide developers with the ability to develop Natural Language Applications for anything but a narrow range of simple assistants when it is clear that voice driven applications of all kinds are desirable.

The reasons behind the limitation of the current systems are historical, and based on the underlying technologies on which the NLP system is architected.

The response component of most modern NLP systems is template-based, and which template to choose is based on regular-expression matching. When parsing an expression, these systems generally do not identify the grammatical structure if the word is not in a dictionary. The best such systems can do was to make partial word matching, and make weak associations with a template. This makes such an approach have limited performance. The lack of grammar is especially problematic for other, non-English languages, that have a lot of different cases resulting in endings for words depending on their position in the sentence, gender, singular/plural, etc. The reason this was accepted in the past was that the basis of the statistical NLP technology was built in 2000s and a dictionary with all such combinations, say in Russian, would be on the order 20 Million words, which would have been impractical to store in memory at that time. Having functional, but limited systems was not optimal, but was a step forward from the systems of the 1960s or 1980s. Since the 2000s, the systems have extended these older approaches by allowing for larger dictionaries, but still tend to rely on exact matching using regular expressions. Furthermore, these systems do not associate semantic interpretations with the text—instead these systems just match text to pre-existing templates.

The preeminent application of NLP today is in Chat bots such as Siri. Chat bots available today are built with one of two goals:
Function-driven: To assist the user in performing simple tasks: For example, Siri has 30-90 built-in functions that it can execute. But the limitations are soon well known by users. If you ask such a system something else not built-in, it says “I don't know.” It has 100 jokes built in to mask this fact, but people have learned them all quickly. It also uses Wolfram Alpha to give information on a fact (more expansive than Wikipedia).
Conversation-driven: To be a “friend” and hold a conversation or entertain the user. A Nanosemantics system is built for this goal. It will continue to “say” things to the user even if it is complete nonsense, just to hold the appearance of having a conversation. Users quickly tire of such toys.

It does not appear that any system on the market does both. This is significant because the utility of a voice driven system is in direct proportion to both the functions such a tool can perform and its usability. And the usability of a voice-mediated system is influenced by the user's ability to reliably engage the system in conversation (for example, to determine an always-listening system is awake and responsive).

Known in the prior art is Johnson, U.S. Pat. No. 5,748,974, issued May 5, 1998, which is said to disclose a multimodal natural language interface interprets user requests combining natural language input from the user with information selected from a current application and sends the request in the proper form to an appropriate auxiliary application for processing. The multimodal natural language interface enables users to combine natural language (spoken, typed or handwritten) input selected by any standard means from an application the user is running (the current application) to perform a task in another application (the auxiliary application) without either leaving the current application, opening new windows, etc., or determining in advance of running the current application what actions are to be done in the auxiliary application. The multimodal natural language interface carries out the following functions: (1) parsing of the combined multimodal input; (2) semantic interpretation (i.e., determination of the request implicit in the pars); (3) dialog providing feedback to the user indicating the systems understanding of the input and interacting with the user to clarify the request (e.g., missing information and ambiguities); (4) determination of which application should process the request and application program interface (API) code generation; and (5) presentation of a response as may be applicable. Functions (1) to (3) are carried out by the natural language processor, function (4) is carried out by the application manager, and function (5) is carried out by the response generator.

Also known in the prior art is Papineni et al., U.S. Pat. No. 6,246,981 issued Jun. 12, 2001, which is said to disclose a system for conversant interaction includes a recognizer for receiving and processing input information and outputting a recognized representation of the input information. A dialog manager is coupled to the recognizer for receiving the recognized representation of the input information, the dialog manager having task-oriented forms for associating user input information therewith, the dialog manager being capable of selecting an applicable form from the task-oriented forms responsive to the input information by scoring the forms relative to each other. A synthesizer is employed for converting a response generated by the dialog manager to output the response. A program storage device and method are also provided.

Also known in the prior art is Weber, U.S. Pat. No. 6,499,013 issued Sep. 9, 2002, which is said to disclose a system and method to interact with a computer using utterances, speech processing and natural language processing. The system comprises a speech processor to search a first grammar file for a matching phrase for the utterance, and to search a second grammar file for the matching phrase if the matching phrase is not found in the first grammar file. The system also includes a natural language processor to search a database for a matching entry for the matching phrase; and an application interface to perform an action associated with the matching entry if the matching entry is found in the database. The system utilizes context-specific grammars, thereby enhancing speech recognition and natural language processing efficiency. Additionally, the system adaptively and interactively “learns” words and phrases, and their associated meanings.

Also known in the prior art is Norton, U.S. Pat. No. 6,246,981 issued Jan. 21, 2003, which is said to disclose a simplification of the process of developing call or dialog flows for use in an Interactive Voice Response system is provided. Three principal aspects of the invention include a task-oriented dialog model (or task model), development tool and a Dialog Manager. The task model is a framework for describing the application-specific information needed to perform the task. The development tool is an object that interprets a user specified task model and outputs information for a spoken dialog system to perform according to the specified task model. The Dialog Manager is a runtime system that uses output from the development tool in carrying out interactive dialogs to perform the task specified according to the task model. The Dialog Manager conducts the dialog using the task model and its built-in knowledge of dialog management. Thus, generic knowledge of how to conduct a dialog is separated from the specific information to be collected in a particular application. It is only necessary for the developer to provide the specific information about the structure of a task, leaving the specifics of dialog management to the Dialog Manager. Computer-readable media are included having stored thereon computer-executable instructions for performing these methods such as specification of the top level task and performance of a dialog sequence for completing the top level task.

Also known in the prior art is Abella et al., U.S. Patent Application Publication No. 2008/0247519, published Oct. 9, 2008, which is said to disclose a spoken dialog system and method having a dialog management module are disclosed. The dialog management module includes a plurality of dialog motivators for handling various operations during a spoken dialog. The dialog motivators comprise an error handling, disambiguation, assumption, confirmation, missing information, and continuation. The spoken dialog system uses the assumption dialog motivator in either a-priori or a-posteriori modes. A-priori assumption is based on predefined requirements for the call flow and a-posteriori assumption can work with the confirmation dialog motivator to assume the content of received user input and confirm received user input.

Also known in the prior art is Kim et al., U.S. Patent Application Publication No. 2011/0166852, published Jul. 7, 2011, which is said to disclose a dialogue system uses an extended domain in order to have a dialogue with a user using natural language. If a dialogue pattern actually input by the user is different from a dialogue pattern predicted by an expert, an extended domain generated in real time based on user input is used and an extended domain generated in advance is used to have a dialogue with the user.

Also known in the prior art is Gruber et al., International Patent Application WO2011088053, published Jul. 21, 2011, which is said to disclose an intelligent automated assistant system engages with the user in an integrated, conversational manner using natural language dialog, and invokes external services when appropriate to obtain information or perform various actions. The system can be implemented using any of a number of different platforms, such as the web, email, smartphone, and the like, or any combination thereof. In one embodiment, the system is based on sets of interrelated domains and tasks, and employs additional functionally powered by external services with which the system can interact.

Also known in the prior art is Cheyer et al., U.S. Pat. No. 8,706,503 issued Jan. 21, 2003, which is said to disclose methods, systems, and computer readable storage medium related to operating an intelligent digital assistant are disclosed. A text string is obtained from a speech input received from a user. Information is derived from a communication event that occurred at the electronic device prior to receipt of the speech input. The text string is interpreted to derive a plurality of candidate interpretations of user intent. One of the candidate user intents is selected based on the information relating to the communication event.

Also known in the prior art is Di Cristo et al., U.S. Pat. No. 8,849,670 issued Sep. 30, 2014, which is said to disclose systems and methods are provided for receiving speech and non-speech communications of natural language questions and/or commands, transcribing the speech and non-speech communications to textual messages, and executing the questions and/or commands. The invention applies context, prior information, domain knowledge, and user specific profile data to achieve a natural environment for one or more users presenting questions or commands across multiple domains. The systems and methods creates, stores and uses extensive personal profile information for each user, thereby improving the reliability of determining the context of the speech and non-speech communications and presenting the expected results for a particular question or command.

It is believed that none of the foregoing art, either alone or in combination, affirmatively addresses the problems discussed above. As a few examples:

Johnson teaches a voice interface as directed primarily at applications using graphical user interfaces on personal computers.

Papineni et al. teach an NLP based method which appears limited in its ability to quickly skip from one type of dialog to another if this method was not programmed a priori.

Weber teaches a multiple-context NLP system where performance is improved by limiting recognition to a combination of one context specific grammar and a general grammar. No conversational dialogs (except simple context-oriented answer cases, which are very few) are supported. It appears that in Weber, multiple templates corresponding to user's request are not simultaneously supported—only first found result in a context is used.

Norton et al. teach dialogs built with a fixed restriction to a single domain of inquiry. The method appears to put limits on user's ability to speak non-prescribed text at any time. Also Norton et al. employs a single dialog database, and there is no way to split the dialog database to support separate programs. Thus it appears that only one solution to one kind of problem can be pursued at one time. A system capable of finding the solution to what might be one or another problem based on potentially ambiguous input must be able to evaluate multiple domains in parallel.

Abella et al. describes how to build a system that provides dialogs with user for only few topics. There is no method to switch context automatically.

Kim et al. describe a system single context system, having a fixed domain where recognition performance is improved by applying an extended recognition domain as a result processing an the initial input set, but does not support a multi step context dependent dialog.

It is believed that the foregoing examples, and the other existing systems, do not fully address the potential for voice interfaces.

There is a need for a NLP system that can carry on a dialog which questions can be posed about multiple topics and where the conversation can return to a previous topic.

There is a need to support long natural conversations with several topics.

There is a need to keep users engaged in conversation.

There is a need to for systems to be more informative and helpful in answering real-world user requests.

There is a need for systems which can infer the need to take proactive action, either in the form of initiating conversation, causing a command to be issued to a device (such as a device participating in the Internet of Things), or causing a command to be issued to a device or data source to gather external data.

There is a need to for systems to learn user's habits and preferences to enable systems to be even more personalized, proactive, entertaining and helpful. There is a need for systems to entertain and emotionally support users.

There is a need for systems that apply information gathered in a series of interactions to both responses directed at the user and responses directed at addressable items which are members of the Internet of Things. Such a system should be capable of supporting natural topic switches while maintaining the threads of a set of prior conversational interactions.

Moreover, for NLP systems to reach their potential a constantly-on system should not only listen for user commands, but should be able to initiate interaction with a user. None of the known systems evaluate the user's environment and needs and proactively take action through as speech driven interface to initiate dialog with a user.

### SUMMARY OF THE INVENTION

According to one aspect, the invention features an NLP system that can carry on a dialog where questions can be posed about multiple topics and where the conversation can return to a previous topic, or several topics prior to the current topic. The present system provides a substantial advance over previous dialog (conversational) based systems, and also supports conventional transaction-based discourse.

In one embodiment, the invention supports long natural conversations that can maintain context about, and respond to questions about several topics.

In another aspect, the invention supplies context retention and its resolution for different forms of speech (such as pronouns) for an arbitrary length of time.

In yet another aspect, the invention provides a system with the ability to hold relevant information about multiple nested topics in discursive conversation for an arbitrary length of time.

In another embodiment, the invention provides features to keep users engaged in conversation.

In another embodiment, the invention provides proactive action, either in the form of initiating conversation with a user, causing a command to be issued to a device (such as a hardware device participating in the Internet of Things) which affects the user's environment or performs a desirable task for a user, or causing a command to be issued to a device or data source to gather external data which will be relevant to a user's needs or interests.

In another aspect, the proactive activation of the system is based on the user's learned needs and on environmental data gathered from a variety of inputs.

In another yet another embodiment, the invention provides more informative and helpful conversational support to answer the needs of real-world user requests.

In another still another embodiment, the system learns and retains user's habits and preferences to enable the system to be highly personalized, proactive, entertaining and helpful.

In another embodiment, the system learns simulated emotions and simulated personality characteristics to engage, entertain and emotionally support users.

In further embodiment, the system both allows context detection and refinement, the application of the information gathered in a series of interactions to responses both directed at the user and responses directed at addressable items, which are members of the Internet of Things. The system supports natural context switches while maintaining the threads of a set of prior interactions.

According to another aspect, the invention relates to providing operating systems architecture to provide powerful, integrated NLP enabled applications, all of which are executing in parallel.

According to another aspect, the invention relates to a method of producing the desired response for the user, be it an action for an IoT device, an action in a software program, or an answer to the ongoing conversation with the user, by generating several assumptions (equivalently, “hypotheses”) of what the response should be, each assumption assigned a rating, where the rating is based on the context of the conversation, the deciphered input, the emotional nature of the character that the digital assistant is playing, a set of known utility commands, as well as the deciphering of the user's original request. All such factors are inherently integrated into a single “total rating” method of ranking such responses, and the one with the highest score is ultimately chosen.

According to another aspect, the invention provides a dedicated programming language targeted at NLP enabled applications.

According to another aspect, the invention allows its NLP capabilities to be used to bootstrap new functionality by providing a voice controlled programming interface, to create new and modify old NLP enabled applications. This aspect enables programming new NLP Apps via the user's or developer's natural language using his or her human voice. According to another aspect, the invention provides Application Program Interfaces to enable external development groups to develop unique solutions for specific applications of interest via NLP Applications. These APIs provide uniform access to NLP processing supported at an operating system level and across multiple NLP enabled applications.

According to another aspect, the invention provides emotional overlay facilities to integrate into NLP applications. These facilities allow simulated personality and behavioral traits to be added on top of any given NLP application's main functionality. The invention further provides the ability to define a variety of emotional overlays expressing personalities of desired characters.

According to yet another aspect, the invention provides a unified user experience with a pre-specified set of quality standards, which can be updated over time.

According to another aspect, the invention provides the capability to “hot-update” NLP applications available to the system without suspending or halting the entire system, in contrast to prior art systems that need to be restarted completely to support any changes in functionality.

### BRIEF DESCRIPTION OF THE DRAWINGS

The foregoing and other features and advantages of the disclosed subject matter will be apparent from the more particular description of preferred embodiments of the disclosed subject matter, as illustrated in the accompanying figures in which reference characters refer to the same parts, blocks, or elements, throughout the different figures. The figures are of schematic and flowchart nature, where emphasis is placed upon illustrating the principles of the invention.

FIG. 1 illustrates an exemplary block diagram of an electronic computing system.

FIG. 2 illustrates a Cloud Infrastructure of Servers and Clients.

FIG. 3 illustrates several electronic devices according to the present disclosure.

FIG. 4: illustrates the overall process From Human Voice Input Request to Computer Voice Output Response—Block Components and Example Distribution across Client Electronic Device(s) and Servers

FIG. 5 illustrates the NLP system stack architecture, the operating system, and applications structure.

FIG. 6 illustrates the data flow mechanism and the data sources in the VOiS operating system kernel.

FIG. 7 illustrates the main cycle of the User or IoT Uniform Request Processing, namely how the data flows from the moment a user or IoT request is issued to producing an Action or Answer.

FIG. 8 illustrates the text clearance block of the main data flow in more detail, with the accompanying databases.

FIG. 9 illustrates the test reduction block of the main data flow in more detail, with the accompanying databases.

FIG. 10 illustrates the parsing analysis block in more detail with the accompanying external databases.

FIG. 11 illustrates the block responsible for the preprocessing by domain specific functions, with the associated internal database.

FIG. 12 illustrates the data flow of a Response Engine 1 in more detail.

FIG. 13 illustrates the method used for generating the Total Rating of a hypothesis for a Response by matching words extracted from a user or IoT request with the word pattern samples, and how the matches affect the rating, whether increasing it to the total maximum rating or hardly contributing anything to the rating.

FIG. 14 tabulates a template matching example how a rating is assigned to a simple greeting sentence.

FIG. 15 illustrates the NLP Apps templates setup, and the dialog search tree.

FIG. 16 illustrates an example of Context Adjustment via two NLP apps, and the associated ratings.

FIG. 17 illustrates as example of searching up and down the dialog tree search and the associated ratings.

FIG. 18 illustrates the data flow of the best response selection from all the rated responses it received as outputs from all response engines and the update to the Dialog History database.

FIG. 19 illustrates the sequential blocks that are called for processing the intended response into a natural human intelligent form.

FIG. 20 illustrates how a basic, pre-installed NLP Apps package is setup, vs. the NLP Apps installed by the user, the latter not having any attributes set up.

### DETAILED DESCRIPTION

The present disclosure describes an NLP system, VOiS, that can carry on a human and electronic device dialog with many related interactions over a period of time. The system uses a hypothesis based detection and refinement architecture which constantly and incrementally processes speech input using a set of response engines which respond to the history of previous dialog inputs and responses.

VOiS supports both utility (template driven) and conversational response engines running in parallel at a core architectural level, not as an architectural add-on. The systems intelligence in based on several “Response Engines”, all of which operate in parallel. A key feature is the ongoing maintenance of numerous hypotheses which are constantly being updated. Each engine may be built to fulfill a separate goal, style or task, and be based on a different technology approach.” Each engine constantly contributes new hypotheses, all of which are ranked and sorted, leading to the next response.

Instead of being limited to one question and answer interaction, or even a series of questions in response to a branch of a dialog tree, the present system retains history of interactions that may be relevant for multiple conversational topics. As a result, information gathered in a series of interactions can be applied to multiple real-world contexts, and the user can switch and mix topics naturally. Data is preserved that can be later applied to responses both directed at the user and to responses, such as commands, directed at addressable items which are members of the Internet of Things. The detection of a change in conversational topic is supported by moving up and down dialog history trees depending on a sequence of interactions.

The system is implemented as a layered operating system, so that common NLP facilities can be applied to any number of voice enabled applications. Unlike NLP systems commonly used, program changes can be made without restarting the overall operating system because data needed to support conversations is stored in a dialog history database, rather than program dynamic memory. Moreover, the system provides facilities for using the NLP interface to perform programming tasks. The disclosure describes a system with a capability for proactive activation based on the user's and environment learned needs. To improve usability and adoption, the system provides a facility for defining emotional overlays for the system's personality, which influence the response styles as well as superficial aspects such as tone and accents.

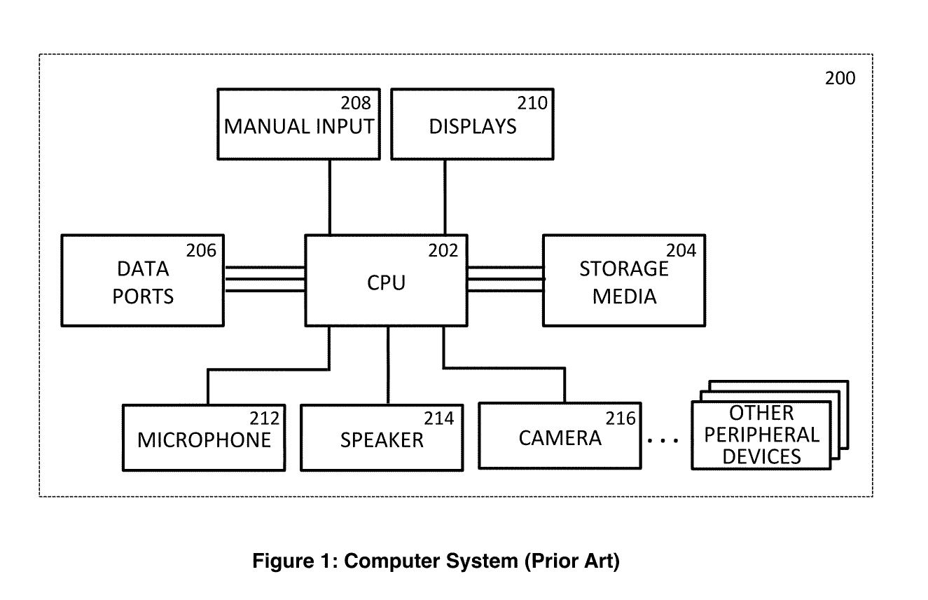

FIG. 1: Computer System (Prior Art)

The present disclosed system, method and architecture may employ off-the-shelf general purpose computers or other electronic devices among its elements. A Computer System or Electronic Device 200 is comprised of a Central Processing Unit (CPU) 202, responsible for all the processing required, and maintaining the connection and coordinating with other devices, Manual Input 208, Displays 210, Storage Media 204 (which could be very fast internal cache memory, simply fast core or flash memory, hard disk drives made of various technologies, or removable flash memory), Data Ports 206 (which could be connected via different communication protocols such as TCP/IP, 802.11 wireless, Bluetooth, Zigbee, or other radio protocols), a Microphone 212, Speaker 214, Camera 216, and other various peripheral devices.

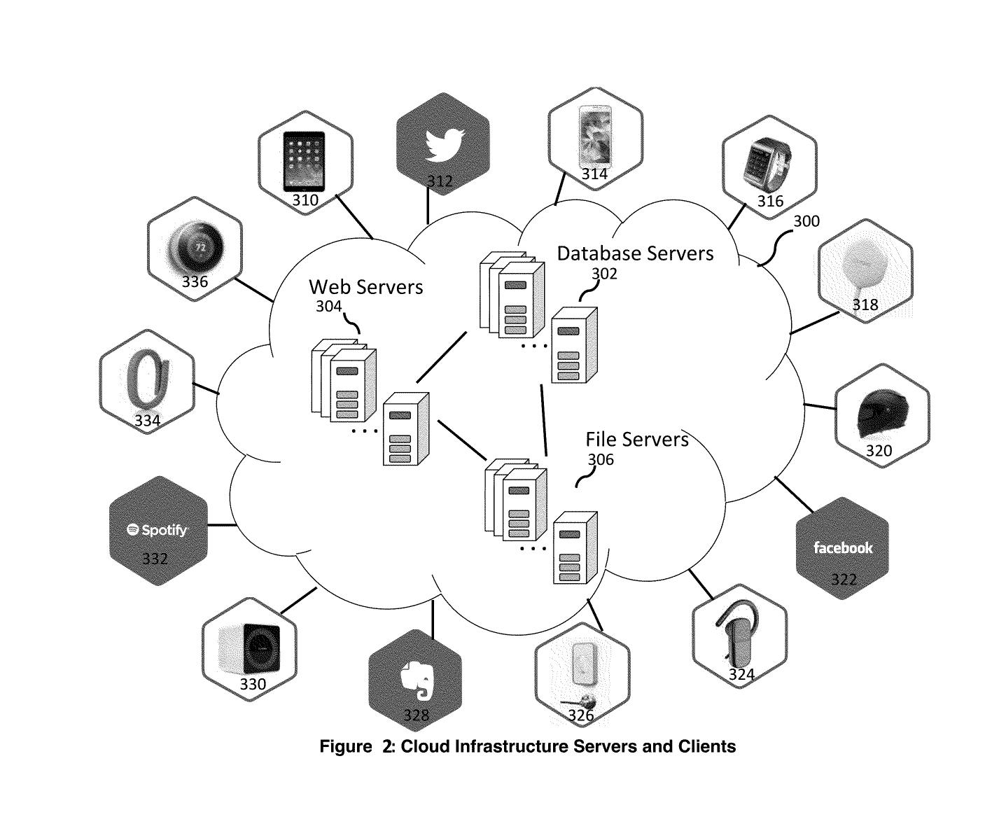

FIG. 2: Cloud Infrastructure Servers and Clients

FIG. 2 illustrates how basic computers or computer systems 200 are combined to form the Cloud 300, also known as the Cloud Ecosystem. Clusters of computers are designated to be Web Servers 304, Database Servers 302, or File Servers 306, all connected via their Data Ports 206 to the Internet Network. Because they are all connected by a network, where these clusters of computers physically reside is immaterial, and we refer to the entire group as the Cloud 300. Such a Cloud commands powerful computing, memory, and connectivity resources. This enables other smaller, Client Computers 310-336 to connect to the Cloud for their computing, storage, and data needs. All such clients are computers or electronic devices 200, and the connectivity of such physical devices to the cloud is also referred to as the Internet of Things (IoT). FIG. 2 illustrates several such client electronic devices, some of which are pertinent to the IoT and others are Applications residing on any of such computers or electronic devices. The system presently disclosed is deployed such as to be generally available to users running client devices having access to the Cloud. We describe these clients, whether existing as fully dedicated hardware or as a reprogrammable combination of hardware and software as follows:
Tablet 310 is a small computer with close to full laptop functionality and wireless cloud access.
Twitter 312 is a social networking App on laptop and desktop computers, as well as on tablets and smart phones, and its entire system resides in the cloud.
Smart phone 314 has cellular, GSM, CDMA, LTE, WiFi, Bluetooth or other similar connectivity, as well as a GPS and a accelerometer, and holds many applications that can connect to the cloud.
Smart Watch 316 is an IoT electronic device that is a miniature and wearable version of the smart phone on a user's wrist, with much of the functionality, but a more miniature and cumbersome input data interface. Such a device may include many applications that would benefit from an NLP interface.
Power Badge 318 is a dedicated device, such as Cubic Robotics product, that is a wearable device on the user's clothes, very lightweight and with a small form factor, that includes a mic and speaker, and connects to the cloud by first connecting to a smart phone via the Bluetooth or other communication protocol or interconnect.
Smart Bicycle Helmet 320 is an IoT device that typically connects to the smart phone via Bluetooth to reach the cloud, and obtains information for the user regarding routes and traffic, while also records user's movements and impact as proactive data and tracking device. It may contain sound input and output means so as to enable access to an NLP application.
Facebook App 322 is a social networking App found on smart phones, laptops, and other computers and whose servers are all in the cloud. An NLP layer may improve the usability of such an this App.
Ear Piece 324 is a simple device that fits into a user's ear, and similar to the power badge comprises a microphone, a speaker, and a Bluetooth chip to connect to the smart phone, which is how it connects to the cloud. Such a device could provide access to NLP Apps.
Smart Socket 326 is an IoT device that enables controlling lighting or any other devices plugged into this socket via various standard radio protocols.
Evernote 328 is a workspace App that provides a more unified platform and visualization for multiple applications such as appointments, e-mail, task lists, etc. and is inherently resident in the cloud, providing each user with his or her own account view on one or more electronic device clients.
Home Cube 330 is a cloud connected electronic device, such as a Cubic Robotics product, that provides a uniform voice interface for the user to the cloud, all the user's applications and IoT devices. All those elements could be controlled not only via the human voice, but also in the user's natural non-coded non-prescribed language.
Spotify 332 is an App to stream music and share playlists from the Cloud on user's multiple client electronic devices.
Fitbit Tracker 334 is an IoT electronic device that keeps track of the user's steps, calorie intake, heart rate, etc. for health reasons, communicates with its own Fitbit App, and stores all such info about the user's account in the cloud.
Nest Smart Thermostat 336 is another IoT electronic device that enables users to program their thermostats in their homes via the cloud, so it could be reset while people are away from their homes, and it also takes into consideration outside and indoor conditions via cloud-based weather information.

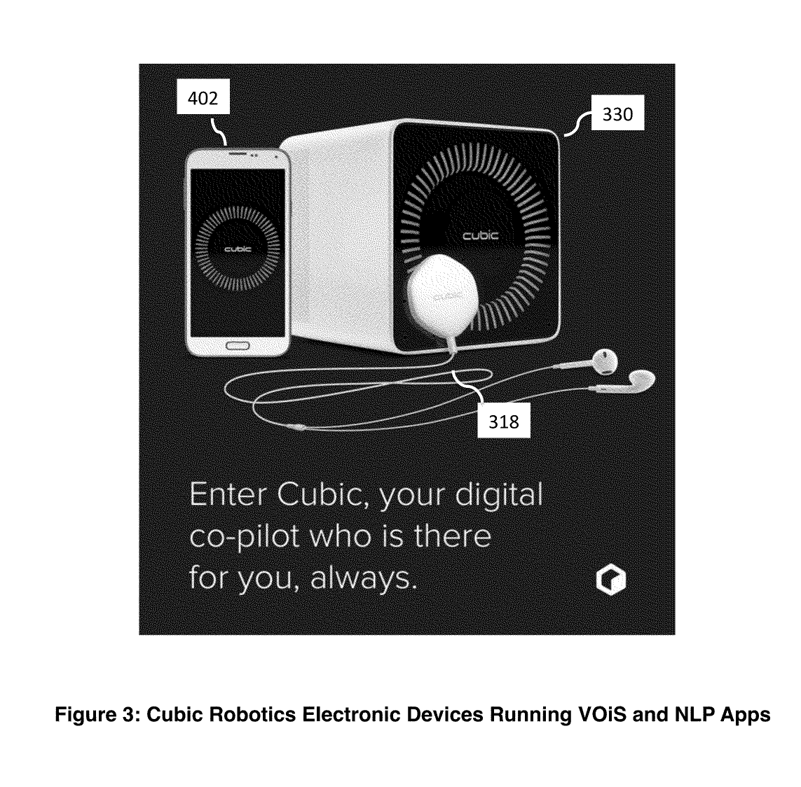

FIG. 3: Cubic Robotics Devices

In this figure we depict actual Cubic Robotics, Inc. products that run the VOiS operating system and various NLP Apps. All these products are illustrative, but not limiting, examples of electronic devices according to the present disclosure that are directly or indirectly connected to the cloud where the main, full functionality VOiS Server resides. Client versions, of varying levels of functionality and power running elements of a VOiS system reside on these devices in different forms. We show three concrete examples, though a person versed in the art will appreciate that many such products using core VOiS concepts are possible:
Home Cube 330 is a device for the home that sits on a dresser or desk and communicates with the user when he or she is in the room. It has a system of microphones to capture speech, and then invokes a Speech Recognition engine recognize it, convert it to text, and then invoke VOiS to run its NLP intelligence to serve the user, and finally respond in the user's natural language reporting on a software or hardware action, or to just carry on a conversation. For the audio response, the Home Cube 402 also has a speaker. The present Cube can be viewed as a computer system connected to the cloud.
Smart Phone 406 is a standard smart phone such as 316 described in FIG. 2 above, running the NLP system and connecting to the cloud. While providing the same voice NLP functionality as the Home Cube, it is distinct from the Home Cube because of the ability of the user to carry it around and leave the house with it, as a smart phone could potentially connect to the cloud not only via WiFi, but also via a cellular, GSM, LTE, CDMA or other equivalent network.
Power Badge 318 was first described in FIG. 2 above, and it not only offers a more mobile version of the Home Cube to connect to the VOiS system, but also a hands-free one. Unlike the smart phone however, the power badge 318 only serves as link between the user and his or her cell phone, and does not have the full functionality of running other Apps. It is equipped it with a microphone, a speaker, and a network chip running the Bluetooth connectivity protocol.

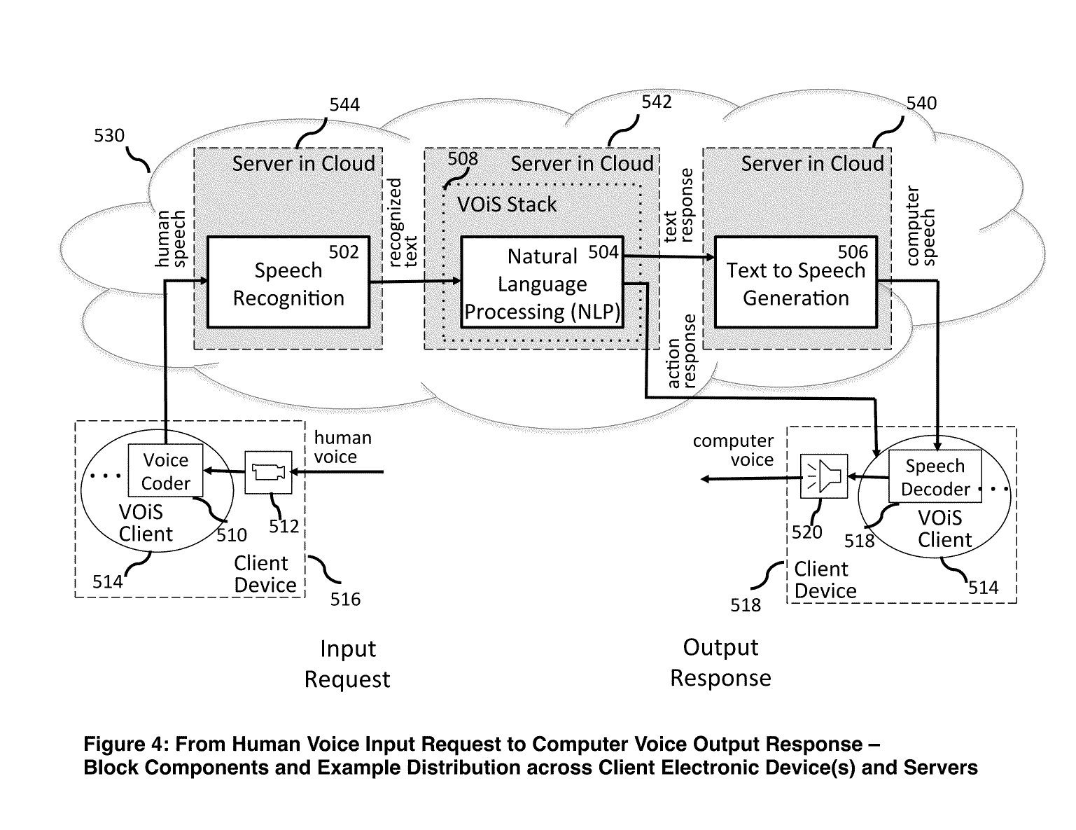

FIG. 4: From Human Voice Input Request to Computer Voice Output Response—Block Components and Example Distribution across Client Electronic Device(s) and Servers

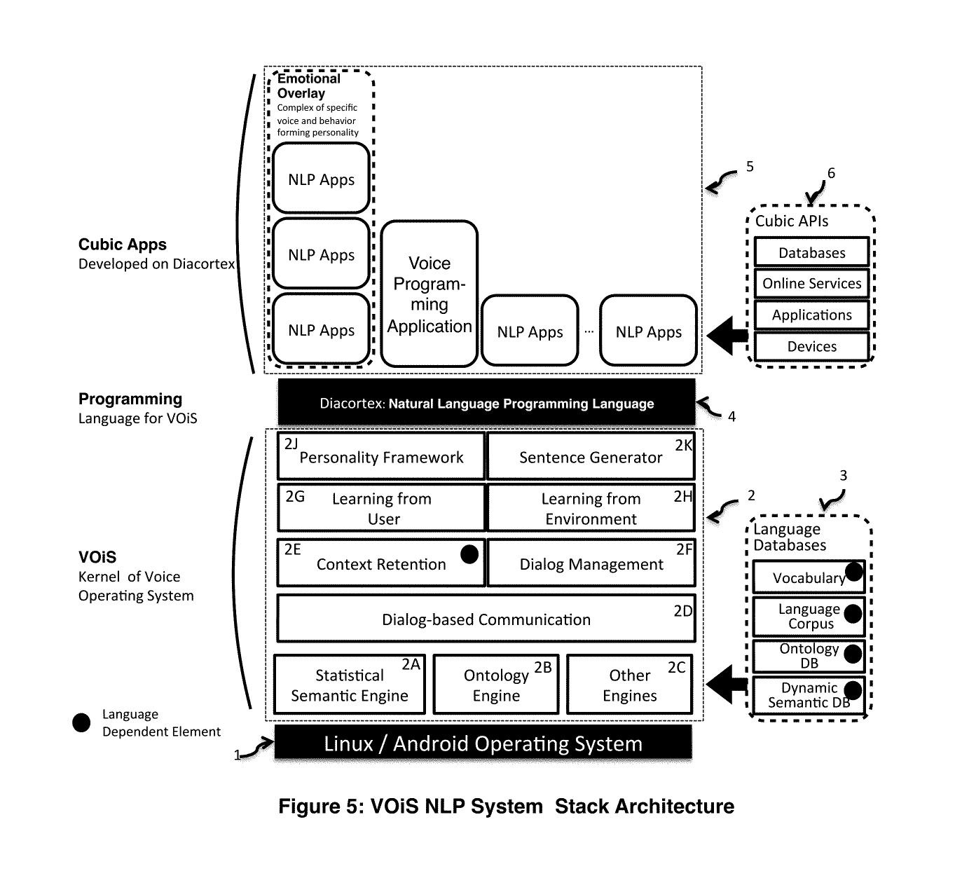

The purpose of this figure is to depict how the VOiS NLP stack architecture of the subsequent FIG. 5 fits into the entire processing and response loop initiated by a human voice input request and resulting in a computer based voice or command output response flow. This figure puts in the proper perspective how the functionality needed to support the entire cycle of conversationally based speech interaction is addressed by this disclosure.

A VOiS client 514, residing on a Client Electronic Device, or Computer, 516, takes as input recorded human voice from a microphone or a set of microphones 512, processes it via a Voice Coder 510 to produce an audio file, and sends this audio file to the a Server 544, residing in the Cloud 530. This human speech input in the form of an audio file goes to the Speech Recognition block 502, which converts it into recognized text. Note that the Speech Recognition 502, is not part of the VOiS NLP Stack of FIG. 5 below. This recognized text is fed into the NLP block 504 of the VOiS Stack 508, residing on Server 542, which produces a text response and potentially an action response. The text response is, in turn, fed into the Text to Speech Generation block 506, residing on Server 540. Similar to the Speech Recognition block 502, the Text to Speech Generation block 506, is not part of the VOiS NLP Stack of FIG. 5 below.

On the other hand, the action response and the resulting output from the Text to Speech Generation block 506 (in the form of computer speech or audio file) are then transmitted to the same or different Client Electronic Device 518, which then communicates with its VOiS Client 514. The action response is processed by the VOiS Client in multiple ways, potentially accessing other Apps or IoT devices and communicating again with the Cloud 530. Typically, the audio file is processed via a Speech Decoder 518, and then voiced to the user via a speaker or set of speakers 520, and the user hears the output from the computer's voice.

This FIG. 4 is illustrative, but not limiting, and demonstrates only one example of how the various blocks may reside across the clients and servers, and the user's electronic devices. In reality, there are many combinations that have been tested against instances of the disclosed VOiS system. For example, the Speech Recognition block 502, may reside on a Server 544, or on the Client Device 516. Similarly, the Text to Speech Generation block 506, may reside on Server 540 as shown, or on the Client Device 516. Along the same lines, the Voice Coder block 510 and/or the Speech Decoder block 518 may reside either on the client devices or on a Server 544 or 540 in the Cloud 530. Furthermore, the Client Devices 516 and 518 may or may not be the same device, but the smooth operation still occurs seamlessly and smoothly without loss of functionality. From the standpoint of the servers, Servers 544, 542, and 540 may all be one server hosting all three blocks 502, 504 and 506, or may all be separate servers as shown, or one server could host two of the blocks 502, 540 and 506, in any combination thereof. Once again, all these combinations have been tested and work seamlessly with no break in functionality or performance.

FIG. 5: VOiS NLP System Stack Architecture

VOiS is an operating system developed to create and execute a voice interface, in any number of applications, between the user and all kinds of electronic devices. VOiS provides software and hardware developers with an environment and tools to build numerous solutions based on the voice and natural language interfaces.

FIG. 5 illustrates the entire system architecture as a system comprised as stack of functionality, comprising five parts:

The VOiS operating system kernel 2 with all the basic logic, algorithms, and protocols. VOiS may be implemented as a standalone system or as running on top of a traditional operating system such as Linux or Android 1.

The Language Databases 3 feeding the VOiS methods with static and dynamically collected information.

Diacortex programming language 4—a high level programming language enabling the rapid development of NLP applications that run on VOiS. This is a powerful tool for developers to build voice and NLP interface programs. Diacortex runs on the VOiS kernel.

Cubic Apps 5—applications developed on Diacortex for VOiS, which comprise:
a. Applications that form the personality of the Cubic products, providing said products with desired capabilities and skills for each respective application.
b. A Voice Programming Application, which allows users to program VOiS based products using the natural human voice as opposed to resorting to writing textual program in the Diacortex programming language or building programs using graphic user interfaces. This Voice Programming Application allows users to develop programs in the form of simple workflows or “if then else” conditional statements.
c. Emotional Overlays—a set of VOiS applications that determines a specific personality of the product. Emotional Overlays allow VOiS based products to behave like renown characters from movies, games, books, or real life.

Cubic APIs 6 offering access to basic usability and utility settings for developers and users which control the voice interface. Examples include the length of the voice transactions in symbols and rules for aborting and closing the NLP applications.

The VOiS operating system kernel 2 is itself comprised of a number of elements:

Element 2A—Statistical Semantic Engine: primarily statistical but also includes non-statistical methods.

Element 2B—Ontology Engine: semantic engine based on conceptual ontologies of the world. This is real world information structured into a schema of computer-understandable data. For example, a particular ontology database related to cooking

Element 2C—Other Engines that could enhance the semantic processing of data are included into the architecture for its future extensibility.

Element 3—Language Databases: these are language dependent databases comprising a vocabulary, a language corpus, an ontology database (with notions in schemas such as “movies”, “home”, “family”, “in car”, etc.), and a dynamic semantic database that is built dynamically during the time of the system operation.

Element 2D—Dialog-based Communication: a system of methods delivering co-reference resolution, discourse analysis, and topic segmentation.

Elements 2E and 2D—Context Retention and Dialog Management respectively: a collection of programmed methods delivering NLP solutions for morphological segmentation, word sense disambiguation and parsing. The system can be set to retain the context for any given period of time, and track a dialog's context nested an arbitrary number of times.

Element 2G—Learning from User: personalization method program elements or libraries which gather, learn, retain, and apply information about the user.

Element 2H—Learning from Environment: programs or libraries for gathering and learning information about the environment.

Element 2J—Personality Framework: program facilities or libraries defining classes and data structures embedded in VOiS to enable the formation of specific personalities defined by developers or users which would enable the personification of fictitious or real-life characters.

Element 2K—Sentence Generator: programs or libraries for constructing natural language sentences from the information required to be delivered to the user via voice.

VOiS is a modular system, and the architecture is built to accommodate a multitude of natural languages. To date, English and Russian have been used. While most of the modules are independent of the intended natural language, one aspect in particular, Context Retention 2E, may have language dependent elements within it. Additionally, the Language Databases 3, are all language dependent. The elements that tend to have language dependent elements are marked with a small black dot.

Universal Voice Interface and Utility Commands

VOiS is built is an intuitive manner for utilization by the user and its extension by dedicated NLP focused or general developers. Every voice mediated NLP system has a baseline of expectations by the user for certain basic actions. The utility commands perform default actions applicable to similar situations for the various NLP Apps. The analog of such commands in a Graphic User Interface is, for instance, the universal method of closing a program window via the “X” icon in the upper right corner of the program window. Having studied this pattern once, the user can use this knowledge for all other programs.

Similarly for VOiS, universal utility commands are commands that can be employed regardless of which program or application is utilized by the user. For example, commands such as the following are generally provided:
a. “Stop talking” or “silence” command makes the device stop interacting with the user, except for the cases, when the user-defined text input is expected.
b. Command “Shut up” makes system to stop the interaction and clear the dialog history.
c. Command “Thank you” stops current conversation and marks the place it stops in the Dialog History
d. “What can you do for me?” obliges the system to sound full list of NLP Apps.
e. “Repeat”—repeat the previous phrase generated by the system.
f. “louder”/“quieter”—volume control with voice for the VOiS based products.

These foundational services are key elements of the System Stack Architecture, which provides the OS, Programming Language, and NLP Apps specifically for voice. These capabilities relieve the developers of the NLP Apps for VOiS from repeatedly programming the basic functions for their applications. Instead, they are able to use the embedded universal utility commands as a baseline set for their applications.

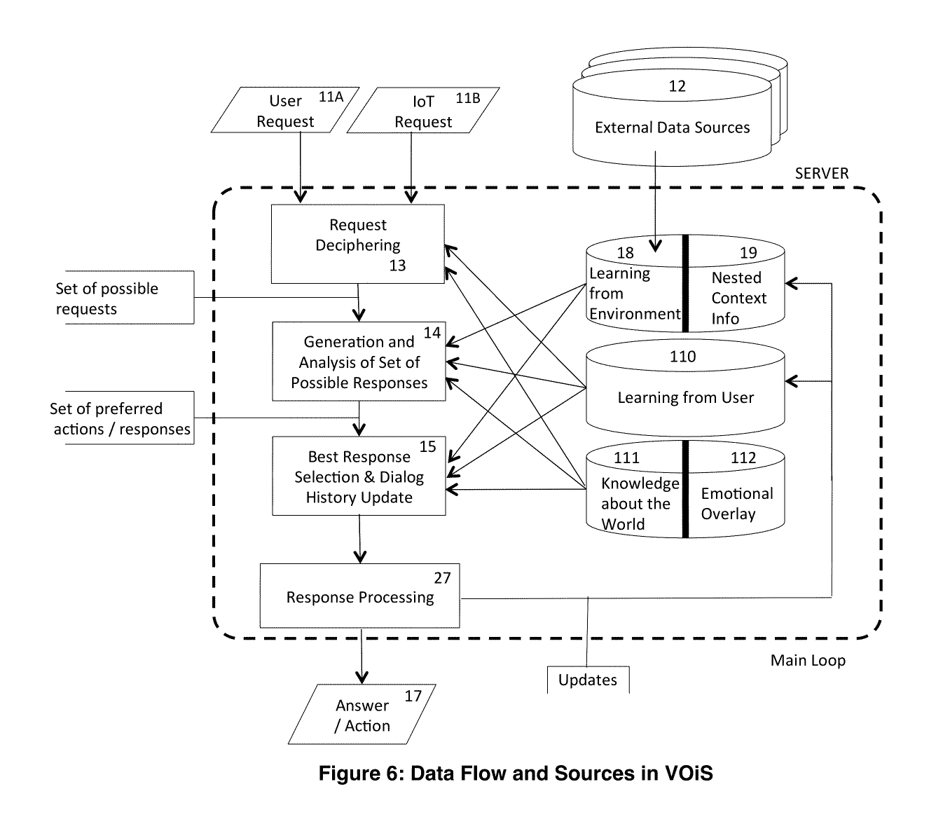

FIG. 6: Data Flow and Sources in VOiS

FIG. 6 illustrates the main concept of the VOiS kernel with its data flow and sources.

The overall goal of the VOiS kernel is that once a user request is received, to determine the best answer and action (such as controlling home automation devices) to execute the desired intent, and thereby help and entertain the user. While the system is in operation real-time, it learns to become more accurate, precise, and becomes progressively more knowledgeable about the user and his or her environment.

The main idea behind how the data flows is to support the ability to generate multiple hypotheses for both the relevance of input speech and for the most appropriate potential answer (response) and/or action, and then select the best option using a method of weights and ratings. The system also records data to support the overall progress of a potentially lengthy conversation between the user and the system.

VOiS uses two types of data in its operation, external and internal data.

A: External data:

User Request 11A: enters the system in the form of text from a speech recognition provider (such as Google, Nuance, etc.). In addition to the text, the system also captures data from the VOiS based device sensors such as information about the tone, voice, or condition of the user's body.

Internet of Things (IoT) Request 11B such as that from a wearable gadget or a hardware connected device: VOiS can process requests from IoT devices or online applications in the same way as the a user's request—be it a notification from a fitness tracker or an alarm signal from the user's security system.

External data sources 12: embodies all kinds of data about the real-time world such as the current weather, or the length of the day. This helps VOiS build a context for its communication with the user. This data is continuously supplied to the system from a set of different sources. Examples are a NEST thermostat, an Uber App, a GPS system, or other web applications.

B: Internal Data:

Knowledge about the World 111: a database with structured information about the world, language and relationships between objects. The knowledge in this database is independent form the user. This database is progressively expanded by developers, and its content is independent of the communication with the user.

Emotional Overlay 112: Information about an instantiated VOiS-based personality and character—including specific behavior patterns. An Emotional Overlay is created by developers and is independent of a particular user's interaction. An Emotional Overlay then determines the VOiS-based product's behavior for a given user interaction, that is the nature of reaction to a specific type of requests, proactivity, etc.

Learning from User 110: This database is generated automatically while VOiS gathers information about the user including user's preferences, habits, and attitudes towards certain topics. Learning from User database 110 affects both precision of the Natural Language understanding and the choice selection of the VOiS reaction.

Learning form Environment 18: This dynamic database contains structured data about the world—time of the day, weather, news etc. Elements of this database continually change in accordance with the real-time state of the world. Learning from Environment database 18 affects both the precision of the Natural Language understanding and the choice selection of the VOiS reaction.

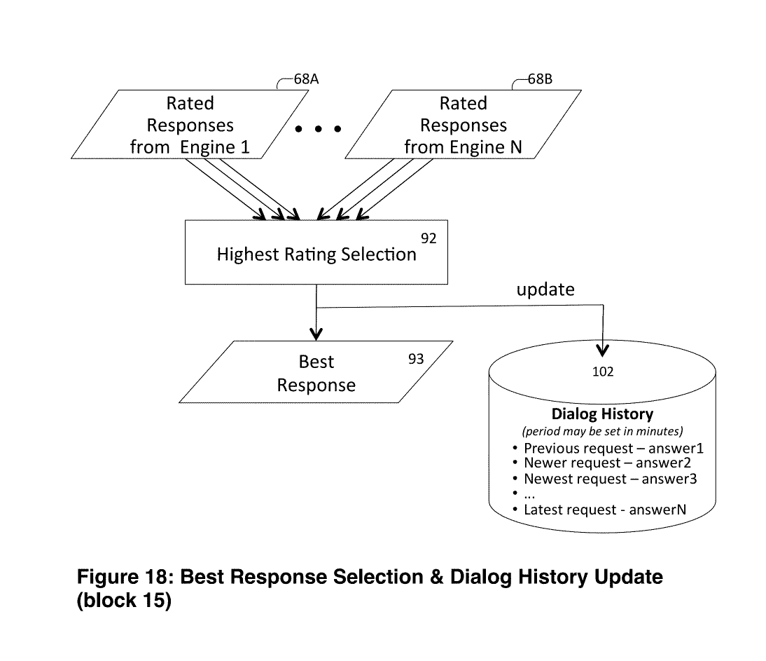

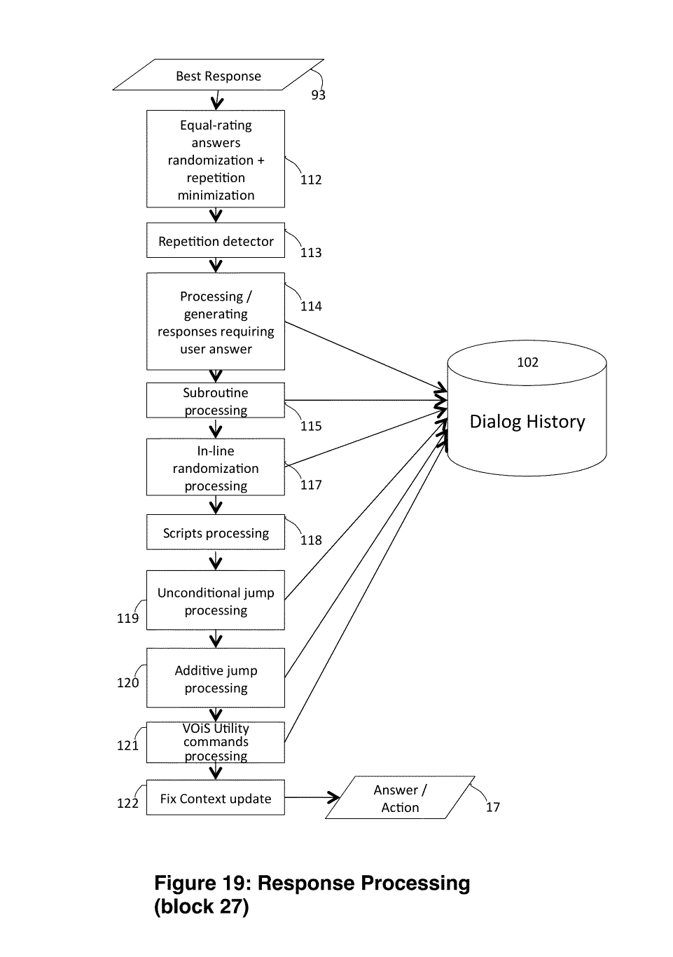

Nested Context Info 19: This database is generated with a history of the current dialog between user and the VOiS based product and also includes the Dialog History database 102 later used in FIGS. 18 and 19. Nested Context Info serves the function of a human's short term memory as it contains the data about the ongoing conversation and dialogs that happened recently. This database enables VOiS-based products to retain multiple contexts and maintain long conversations. It also significantly improves the precision of natural language understanding and quality of the correct choice selection of the VOiS reaction.

Data Flow Processing—Main Cycle:

A User Request 11A or an IoT Request 11B is analyzed by Request Deciphering 13 to generate a number of hypotheses of what the user actually means by this request. On the basis of a set of hypotheses on how best to respond to this “deciphered” request, VOiS performs the Generation and Analysis of Set of Possible Responses 14 (actions and answers), wherein every such potential answer and action are assigned a rating weight. These weights determine the level of relevance of each potential answer or action in the current context and other externally and internally accumulated knowledge. Answers may be scored based on data from internal bases such as (for example):
a. Learning from Environment 18
b. Nested Context Info 19
c. Learning from User 110
d. Knowledge about the World 111
e. Emotional Overlay 112

VOiS selects the best response (natural language answer, action, or both) having the maximum rating as a response to the User Request or IoT Request in Best Response Selection and Dialog History Update 15, which, as the name suggests, also updates the Dialog History database 102. Next, it is phrased into humanly comprehensible language by Response Processing 27 to determine what VOiS needs to output or what function to perform as a result of this selection. At this time, the Nested Context Database 19 is again updated to retain the context of the current dialog. Response Processing 27 is also used to update Learning from the User Database 18 to keep a historical database about the user. This feedback loop of updates enables VOiS to provide the user with progressively more precise and personalized answers and/or actions. The resulting Answer/Action 17 is then generated and an external text-to-speech engine is invoked to respond in the user's natural language. If the Answer/Action 17 involves a certain action within a software application or a hardware device, this action is also executed.

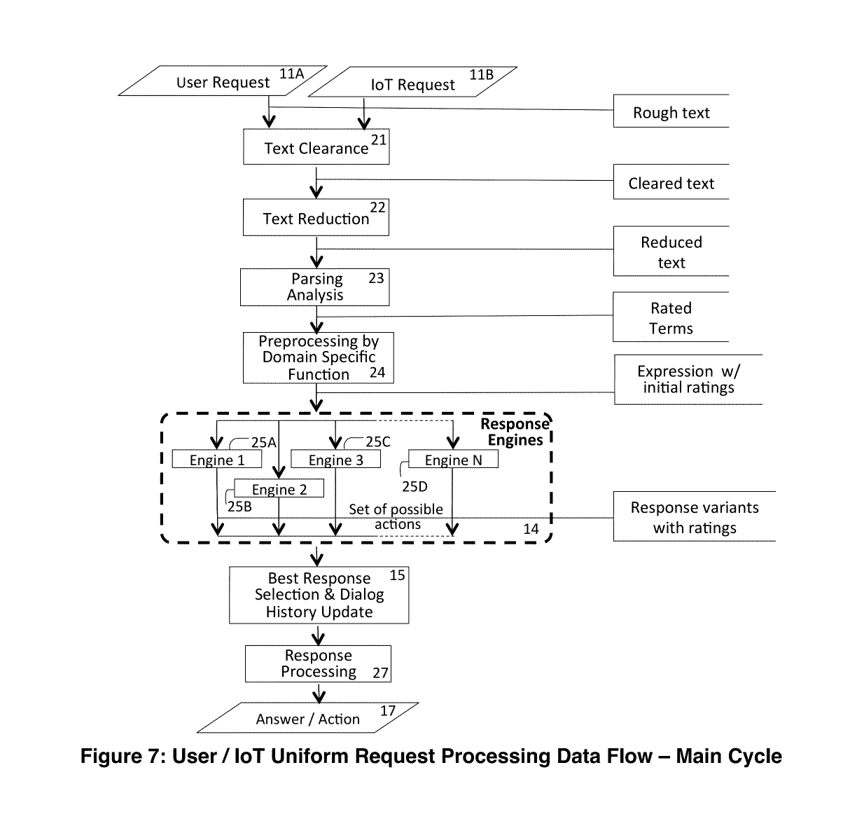

FIG. 7: User/IoT Uniform Request Processing Data Flow—Main Cycle

FIG. 7 illustrates the main cycle of the data streaming request, coming from either User Request 11A or IoT Request 11B. It is noteworthy that the system does not discriminate between either of those two types of inputs. Rather it processes such inputs in exactly the same manner. This provides robustness to possibly sloppy programming on the part of IoT developers, because even IoT inputs obtain the benefit of the NLP programmed analyses.

This User/IoT Request Processing cycle has three overall goals:
a. Reduce the entropy of the text or action/command of the input to the system, without losing any of its semantic meaning A relatively elaborate scheme to achieve this goal is implemented in VOiS, making use of at least fuzzy logic, hypotheses, and refinement of intermediate terms and concepts.
b. Research and select the best response to the request or action or user's question, by taking into consideration the context of the on-going dialog, the external environment, user's developed preferences, and other information.
c. Formulate the response to the user, or report on the action performed on the user's behalf, in a natural language form, that would flow naturally with the ongoing dialog.

Blocks 21, 22, 23, and 24 are all tasked with disambiguating the input user or IoT request, thereby fulfilling the first overall goal of this main loop. The inputs appear as rough text to the system, which then passes through the Text Clearance block 21, to produce cleared text free of unnecessary punctuation or by mapping superfluous symbols to a single character. This facilitates further processing. A Text Reduction block 22 in turn processes the cleared text, and disambiguates the syntax into simpler and a more machine-readable format, to produce reduced text. Subsequently, the Parsing Analysis block 23 analyzes the grammatical syntax to extract the true semantic intent via using the Word Form Dictionary 54 and Language Corpus 56 databases. This newly processed semantic data is now coded in an internal VOiS format, and this expression is served as input to Preprocessing by Domain Specific Functions 24. This latter block is tasked with matching the user's and world's views to disambiguate the semantics of the input data, and assigning it a weight. For example, multiple greeting phrases may all be substituted by the single word “hi”. Preprocessing by Domain Specific Functions occurs iteratively by utilizing a Domain Specific Functions database 73 until the resulting data is stable—meaning no changes are substituted in the last iteration. When stability is detected, processing continues to the next block.

Note that although an IoT Request 11B, will undergo all the aforementioned processing via blocks 21, 22, 23, and 24, many of them will be null or degenerate cases. The goal is to dramatically simplify the interface to VOiS, and relieve the developers desiring to interface with VOiS from the burden of writing, testing, and rolling out new applications. Rather, all the burden of “figuring it out” is placed inside the VOiS artificial intelligence. This way, devices can get “hooked” into VOiS real-time, and get processed without requiring system downtime or a cumbersome setup. Another key advantage is the resulting modularity of VOiS as a system, which enables its evolution with time. Finally, programmers could not be sloppier, less structured, and must faster in how they write the NLP Apps, because the core intelligence is within the VOiS system.

To achieve the second stated goal of researching and selecting the best response, we employ blocks 14 and 15 as follows. The preprocessed data with its initial rating is input into the Response Engines block 14, which is comprised of several intelligent engines (blocks 25A, 25B, 25C, 25D) that match the probable desired response to various templates via statistical techniques, template techniques, or other methods, and reference many complex static and dynamic structures as well as internal and external databases within the VOiS system. Each such potential match is given a weighted rating. Best Response Selection & Dialog History Update block 15 selects the answer with the highest rating from among all those provided with their associated weights, and updates the Dialog History database 102 accordingly, recording the current context and the answer given to the user.

To achieve the third and final goal of communicating the resulting answer, or report regarding a performed action, to the user in a human-like natural language, while preserving the layered personality and context, block 27—Response Processing undertakes this task via a complex set of processes and utilizing the Dialog History database 102.

In what follows, we describe each of these blocks and the corresponding methods used in more detail.

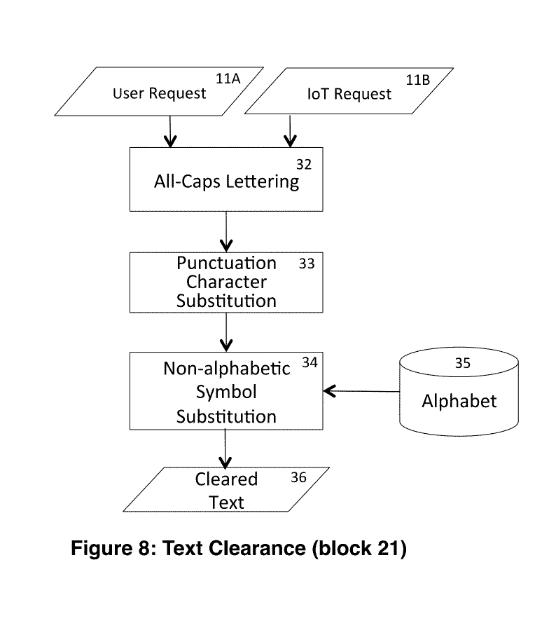

FIG. 8: Text Clearance (block 21)

The primary goal, which is known in the art, of this block 21 is to “clean” the text generated by the input requests User Request 11A and IoT Request 11B from superfluous words or phrases that add little or no meaning to the semantics, but are often present due to the traditions in human language. Step by step, we reduce the entropy of such text as follows:

All text is reduced to one register and converted to all-caps by All-Caps Lettering 32.

Punctuation Character Substitution 33 replaces all grammatical punctuation such as commas, semicolons, exclamation marks, etc. with a canonical space character, which simplifies the text.

Non-alphabetic Symbol Substitution 34 also replaces rare symbols with more basic symbols or spaces according to pre-determined rules from the Alphabet database 35.

The resulting output is Cleared Text 36, which serves as input to the next Text Reduction block 22.

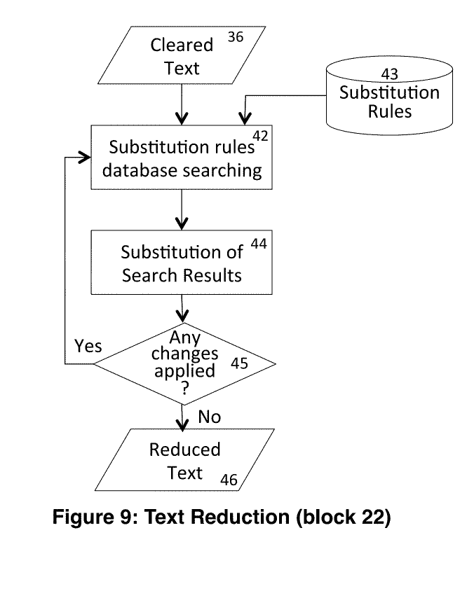

FIG. 9: Text Reduction (block 22)

The goal of Text Reduction block 22 is to further reduce the entropy of the input text, with which VOiS is currently working, by disambiguating complex words into more canonical synonyms or replacements and make it simpler to convert to a machine-readable format. This is accomplished by maintaining a Substitution Rules database 43, conducting the Substitution rules database searching block 42, performing the Substitution of Search Results block 45 if there is a hit. Some examples of such substitutions are parasite words, complex expressions, or common errors of the Speech Recognition application.

This is an iterative process that repeats itself until no substitution occurs at a certain iteration, as tested by the block 45 Any changes applied?, and if not, the procedure exits with a more simplified Reduced Text output 46, which in turn serves as input to the next processing block 23 Syntax Analysis.

This kind of reduction loop (perhaps analogous to an “auto-correct” function well known in word processing) is thought to be unusual in template based NLP, because conventional template-based approaches using pre-programmed regular expressions are thought to find exact matches to the input text. A requirement for exact matches would preclude using the fuzzy logic matching expected to be of benefit in this step.

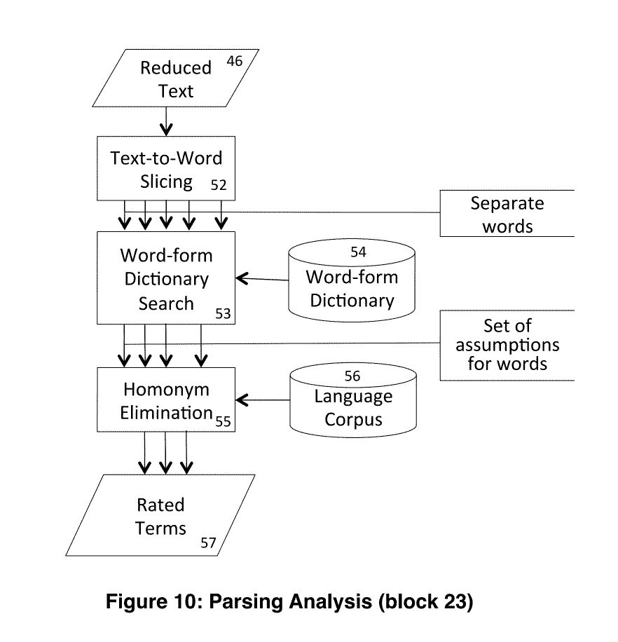

FIG. 10: Parsing Analysis (block 23)

The goal of this block is to syntactically identify the words in the Reduced Text 46, such as determining which are nouns, which are verbs or adjectives, etc., and subsequently to understand their overall semantic meaning. For example, VOiS could have two hypotheses regarding the phrase “I want to eat toast”:
Hypothesis A: “toast” is a noun
Hypothesis B: “toast” is a verb

The Parsing Analysis block 23 should be able to probabilistically exclude Hypothesis B because in the English language using two consecutive verbs is less probable than the verb-noun combination.

This is implemented by using both syntactic and semantic analysis. One approach, referencing a Language Corpus and Word Form Dictionary database (which is known from prior art in a different domain but not known by persons of ordinary skill in the art to be used in NLP) has its origins in Search technology (such as Google Search, to determine what exactly the user wants to know, or said another way, to extract the main goal of user's request). This technique could be used to help the system obtain the intent, and then execute what the system understood the intent of the user to be.

However, VOiS takes a different and (which is also more complex and therefore costs memory and response time): It turns all matches into hypotheses, and assigns each hypothesis a rating. All these generated hypotheses and their associated rankings are then carried throughout the rest of the data flow streaming, with the rankings being refined as more and more considerations and aspects are being processed. This dramatically improves the accuracy of the results. The approach is well suited to parallel execution, allowing both precision and responsiveness.

Procedurally, the Reduced Text 46 is broken down into separate words via the Text-to-Word Slicing block 52, and then for each such word the Word-form Dictionary Search block 53 searches the Word-form Dictionary database 54 and produces a set of hypotheses regarding the semantic meaning of each such word. Which of these hypotheses is correct is resolved by the Homonym Elimination block 55, which consults the Language Corpus database 56. The Language Corpus is constructed with probabilistic ratings of each hypothesis—the higher the frequency of such a sentence structure in the language, the higher the rating assigned to such a hypothesis. All these hypotheses with their respective ratings are output as Rated Terms 57, and carried through to the next block.

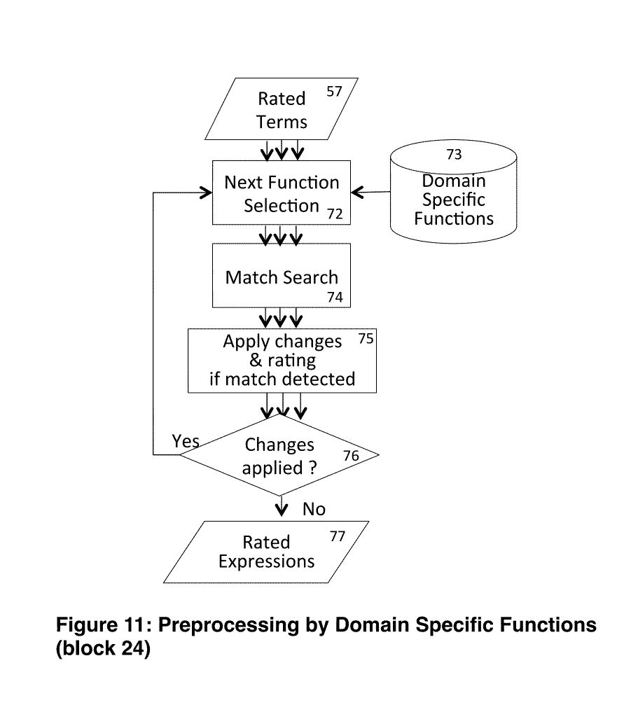

FIG. 11: Preprocessing by Domain Specific Function (block 24)

Having disambiguated the syntax of the input text into a set of rated hypotheses (presented as Rated Terms 57), the next goal is to attempt to simplify the format of the word string into the simplest possible form, so it can be represented in a machine readable data structure. This simplification is easiest to do by constructing domain-specific views of the world, and it may be possible to represent a given view of the world effectively via such a domain specific approach. However, the present system does not settle for a single possibility, and cycles through all available domains, just in case one fits more than the other, and discovers a fit. Each fit can be thought of as a hypothesis about the word string's meaning, and the existence of multiple fits means that there is a set of potentially correct hypotheses. As an example of understanding the actual semantic meaning of the original request and matching it to the user's expectation of the world, consider various kinds of greetings. Phrases such as “how are you,” “how are you doing,” “hi,” “hello,” “what's up,” “doing well today,” etc. would ideally all be substituted to a single canonical “hello.” Kitchen appliances may be another domain, as is obtaining an answer from a software application is yet another domain, etc.

The system's data flow technique is to carry the entire set of hypotheses through all the blocks. Because there could be a very large number of hypotheses, it is imperative to reduce the number of hypotheses to the extent possible without losing the semantic meaning of the user's intent. To do this, this block generates an internal “machine-understandable” language. The representations are complex, involving complex data structures with indexed functions, hash tables, lists, registers, etc. all residing in memory.

This reduction in number of assumed user requests, each tagged with an associated rating, simplifies further processing. This simplification occurs on the basis of the rules entered in the Domain Specific Functions database, which is modular. As other domains emerge in the world, their rules can be entered accordingly.] The system cycles through all such domain functions to see if any of them fit, and do it for all the hypotheses w/ the ratings. The simplification is iterative and continues for each hypothesis until all possible replacements are made, as follows.

VOiS maintains a set of templates in the Domain Specific Functions database 73, which enables the Next Function Selection routine 72 to select various templates from the Domain Specific Functions database 73 by function. The Match Search routine 74 checks whether the template of this function matches the term, and if a match is found, the Apply changes & rating if match detected block 76 performs the substitution and the process is repeated for other functions. This iterative routine exits when a match is no longer found. The output of this block is are Rated Expressions 77 in machine understandable format, and this serves as input to the Response Engines block 14.

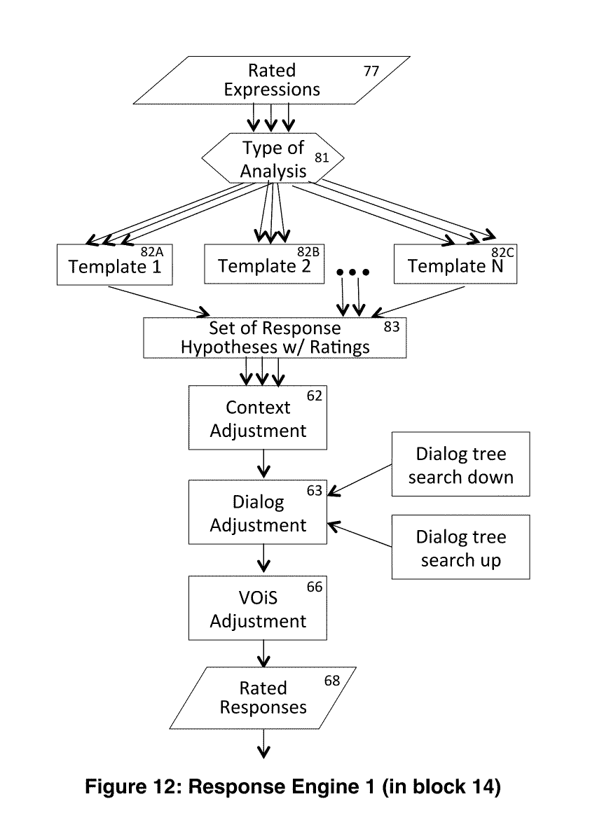

FIGS. 12 & 13: Response Engines and the Rating System (block 14)

The standard approach in the art is to construct templates represented by regular expressions, where each template is associated with a pre-determined action. These conventional systems distinguish themselves from each other by employing more and more elaborate regular expressions, but the mechanics of the process remain essentially the same. Once a match is found, the response (action/answer) is determined and the process exits.

In VOiS a different architecture is used to attack the problem, wherein one or more Response Engines employing varying technologies are run in parallel to enable very robust and flexible determinations of good outputs.

FIG. 12: Response Engine 1 (in block 14)

Once VOiS has produced its best guess at what the input request means syntactically and semantically, and has this information in the form of a Rated Expression 77, it is ready to undertake the complex task of analyzing and producing the desired response, be it a simple answer via voice, or by issuing a command, or set of commands, to execute a task that needs to be performed with a software application or a hardware device in the IoT eco-system. The goal of the Response Engines block 14 is to generate a set of Rated Responses 68, each of which could potentially be the desired response. The input to this block in VOiS is a set of data each of which carries a semantic meaning Effectively, what enters the response engines is a set of “intent” hypotheses.

It is noteworthy that in this block 14, VOiS may have one or more Response Engines, any number of these engines operating in parallel, depending on how expansive an overall world of interaction with the user is to be supported and the diversity of the IoT eco-system to be supported. The type and number of response engines may also vary with the overall goals and styles of a given instance of a VOiS system or set of NLP applications deployed on that instance of a VOiS system. Additionally, due to the modularity of VOiS, new engines with new methods could be easily added at any time to operate in parallel with the existing engines to accommodate needs to expand the reach and functionality of the system and NLP applications in the real world, and in response to new concepts, expectations, and constructs entering into the users' lives.

Different technologies for response engines have different strengths in this regard. For example, one engine may be statistically based, the other more linguistic. One engine may primarily be in charge of “servicing” the user or executing an IoT function, while another engine's goal may be chatting with the user, being entertaining, and keeping him or her company. In VOiS, it is not an either or proposition as is in prior art, rather, VOiS runs all engines in parallel suggesting potential responses, enabling the best response to come from the appropriate engine. VOiS's multiple engines support multiple goals in using the method most appropriate to each. VOiS's multiple engines support the shades of gray that exist in the real world, and provide the ability for the system to come up with relevant responses that will surprise the users. The collection of response engines may be expanded to the point where large populations of such engines may provide a Society of Mind capability that would appear intelligent to the users, and would certainly be very useful to users in everyday situations common enough that it was worth a developers' time to build a specialized response engine.

As a few illustrative examples of what having a dedicated response engines for each purpose addresses, consider three of many possible examples:
a. Engine 1: Goal is action-based, implemented say for the sake of argument, via regular expressions, generates embedded solutions where actions result, typically as commands to members of the Internet of Things.
b. Engine 2: Goal is to hold intelligent conversations/dialog with a user, not to take actions.
c. Engine 3: Goal is to have the capability of optimized, automatic logical deductions of what the user actually meant or intended, even if it is not said—something humans do all the time, and which a specialized response engine may focus on providing.
d. Engine 4: Goal is to detect emergency situations, such as distress in a user that might be the result of something happening in the user's environment.
e. Engine 5: Goal is to support a sequenced interaction with an external service, such as a web-service enabled cloud application such as an e-commerce site or a governmental agency.
f. Engine 6: Goal is to detect a user's need for food or entertainment.

Many such engines are possible, and the behavior of a given VOiS system may change either subtly or dramatically depending on the combination of response engines operating in parallel. Then number of response engines may be varied dynamically in response to available computing resources and present system load.

Having multiple engines executing in parallel allows the use of engines that are complementary to each other. In conventional systems, if one attempts to combine multiple technological approaches in one mechanism, these approaches tend to conflict with each other. For example, such as the game of chess—once you have a strategy a linear system would have to follow it through and could not follow another strategy because that would demand a contradictory placement of the pieces. A parallel approach is clean and powerful, allows implementing engines different goals (and different technologies) to keep running whether or not the outputs are fully relevant to the user at that moment. Because the dialog history is kept, the outputs of those systems may become relevant and highly ranked as the conversation continues.

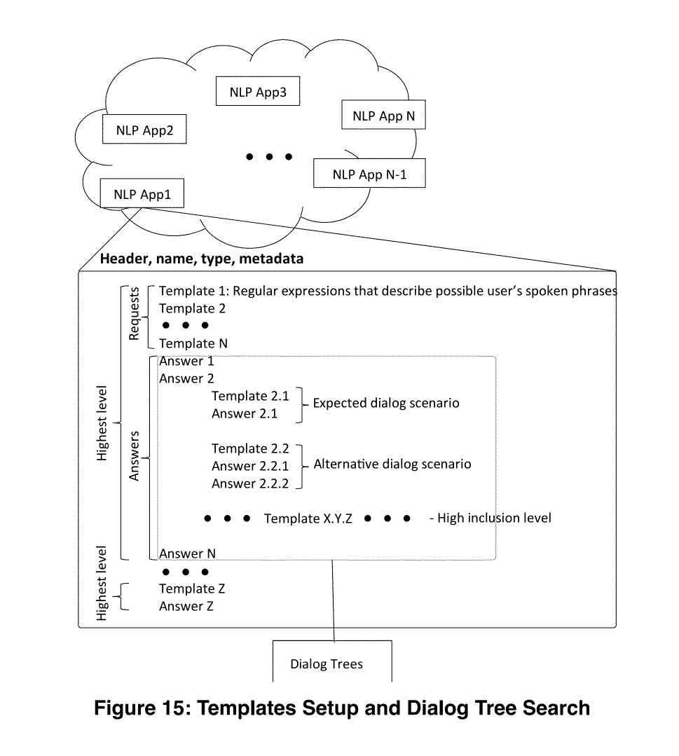

Here, we describe in detail only one exemplary Engine 1, which is a modified template-and-statistical-based engine, and a complex part of VOiS with involved methods and structures. This engine differs from those well known in its use of fuzzy-logic matching. The method by which Engine 1 sets up its templates and for which dialog context is illustrated in FIG. 15: Template Setup and Dialog Tree Search. On a functional level, Response Engine 1 is described within this FIG. 12 schematically, and operates as follows.

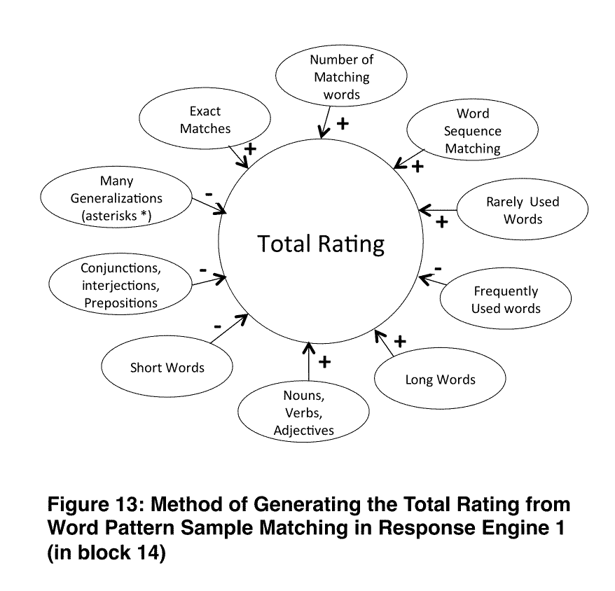

Taking the Rated Expressions 77 as input from the Preprocessing by Function block 24, the Type of Analysis block 81 sorts the input across a range of different classes of templates, and, depending on the type of analysis it deems is required, a fuzzy logic template matching occurs. If no match is found, then no response is generated for this template hypothesis (as it is equivalent to rating zero), and this template is dropped altogether, such as depicted for Template 2 in FIG. 12, where no arrow is generated as output. For templates with any kind of matches (even weak matches), VOiS then performs a sample pattern probabilistic analysis across the various classes of Templates 82A, 82B, . . . 82C, which results in a Set of Response Hypotheses with Ratings 83. The ratings are calculated via the method described in FIG. 13, and this method is applied to every generated hypothesis for generating the response—a mechanism taking into consideration an arbitrary number of factors such as information from databases, external, and internal, dialog based factors, system-based factors, etc., but which are all unified via this uniform ratings system.

Note that unlike conventional template Regular Expression matching, fuzzy logic is appropriate and helpful here because multiple results are useful to the data processing used in VOiS. In prior art, a typical system looks for a single match with a regular expression. In contrast, VOiS is architecturally different in that it tracks and carries forward fuzzy-match coefficients for many potential matches. This will allow VOiS to defer selection of responses until the embedding of all factors into the total ratings is complete and only then evaluated en-masse.

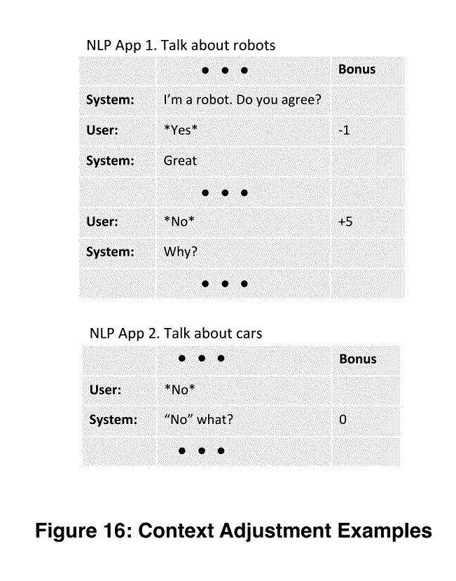

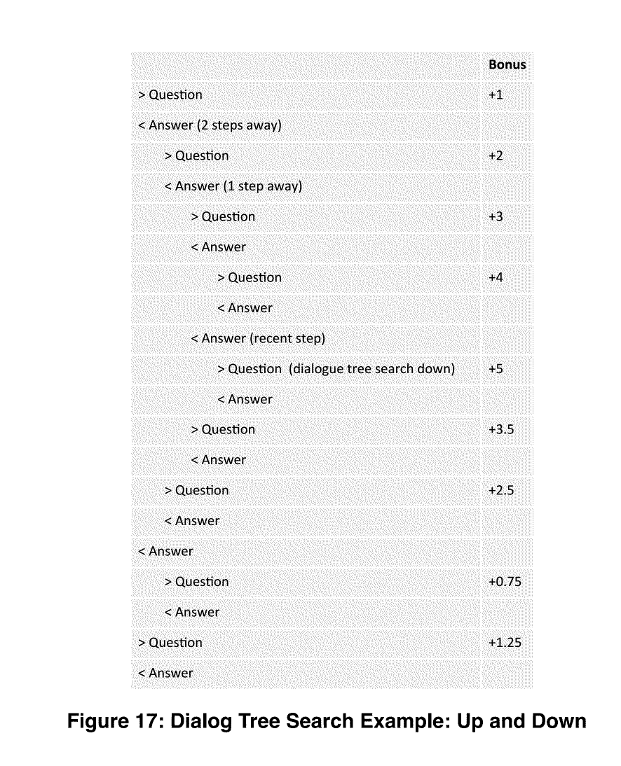

In an exemplary embodiment, these ratings may adjusted according to the following modifiers:
a. Context Adjustment 62: This modifier is added to the Template's rating if it is in the context of a conversation. Moreover, the closer the Template is to the context of the current or previous topic of the conversation, the higher the modifier coefficient. The same situation is applied to timing. The less time elapsed from the previous communication on the same topic, the higher the value of modifier coefficient. Examples of how the ratings are adjusted based on the current context are tabulated in FIG. 16. The context adjustment is naturally weaved in at this point, as a part of the overall rating system, rather than being a separate activity.
b. Dialog Adjustment 63: This modifier is added if the template fits as part of the dialog. Hypotheses that provide VOiS with the ability to continue the dialog are assigned a higher modifier coefficient. Conversely, hypotheses that do not meet the requirements of Nested Context Info database 19 (shown in FIG. 6) are assigned a lower modifier coefficient. This adjustment enables VOiS to be proactive in suggesting other contexts to the user by not only going down a tree branch via Dialog tree search down 64, but also going up the dialog tree with Dialog tree search up 65. FIG. 17 tabulates an example of traversing the Dialog Tree Search and how the corresponding “bonuses,” which contribute to the resulting ratings for each hypothesis, are assigned. As with context, the dialog adjustment is naturally woven in as part of the overall rating system. Other systems typically have a separate module called Dialog Manager which sits separately at the beginning or end of the system. In conventional systems' Dialog Managers, the processing sequence allows the method to go down the tree to find the dialog context, but if it is confused, it does not search up-the-tree to propose a different dialog context. Instead, the Dialog Manager's execution falls off the branch and has to re-start. In contrast, VOiS initiates up-the-tree searches for Dialog contexts, and since everything is rated, eventually VOiS picks the one with the highest rating based not only on the various dialog context, but with respect to other factors woven into the rating as well. So here, the dialog is an inherent part of the core architecture, and therefore its contribution is very flexible within the Response Engine. An illustrative example of going up the tree search and how it can be useful would as follows: If the digital assistant/friend asks whether the user's charge card is debit or credit, and the user then answers “Master Card,” then we have a response that doe not actually answer the question properly. By making use of tree logic representing the card ontology, VOiS may be able to branch to a different dialog tree, figure out that if it knows the user does not have a credit card that is a Master Card, then it must be Debit. The system can then return to its original response path.
c. VOiS Adjustment 66. If the template is marked as a VOiS Utility Command Template (as described in the text regarding FIG. 5) then it is assigned a high modifier coefficient for the probability rating. A list of such Utility Commands is found within the description of FIG. 5 above. This adjustment provides precedence for Utility Commands. Processing the “Utility” commands present in mix with the user's regular speech, within the normal processing sequence as an adjustment, is a very flexible method to process incoming speech related to commands in such a way as to streamline the architecture and to benefit from improvements in architectural components without having a special utility command module to maintain separately.

Finally, a set of Rated Responses 68 from Engine 1 is generated as output. Similar outputs are generated from all the other engines running in parallel. Then, the entire set of these outputs from Response Engines block 14 are passed along as inputs to the

### Best Response Selection Block 15.

At this point, the system has preserved numerous possibilities numbering on the order of the product of the number of outputs of the Request Deciphering 13 multiplied by the number of Response Engines 14, multiplied by the number of rated responses from each engine. The preservation of this amount of data is an integral and distinguishing characteristic of the VOiS architecture, and may dramatically improve the accuracy, scope, and responsiveness of NLP applications.

FIG. 13: Method of Generating the Total Rating from Word Pattern Sample Matching in Response Engine 1 (in block 14)

This figure is not illustrated as a block in the flow chart, because it describes the mechanism of how a Total Rating is calculated for each response hypothesis as employed within exemplary Response Engine 1 (block 14).

To compute a Total Rating in each case, a comparison is conducted with word pattern samples to check the response hypothesis and assign it a probability rating. A Word Sample Pattern is a regular expression in a language that describes many different text constructs. The main ideas behind this method are:
a. The fewer the phrases by which we can describe the word sample pattern the higher the sample pattern rating. This is because being able to match sample patterns that enables such a reduction, without a loss of relevant information, furthers the confidence of by decreasing the ambiguity. As a special case, we assign “*” to describes phrases and with minimal ratings.
b. The more accurate the match between the input phrase and the word sample pattern the higher the contribution “bonus” to the total rating.

The probability rating of each hypothesis is influenced by a series of factors, either additive or subtractive. For some non-limiting examples:

Illustrative Examples Positive coefficients raise the value of the rating:
a. Number of coincided words
b. Words sequence matching
c. Rarely-used words in the phrase
d. Long words
e. Nouns verbs adjectives
f. Exact match

Illustrative Negative Coefficients do not Effectively Contribute to Reaching the Maximum Possible Rating:
a. Frequently used words
b. Short words
c. Conjunctions, interjections, prepositions
d. Many generalizations

Those generally versed in the art would understand how to extend such criteria based on the foregoing, non-limiting, examples.

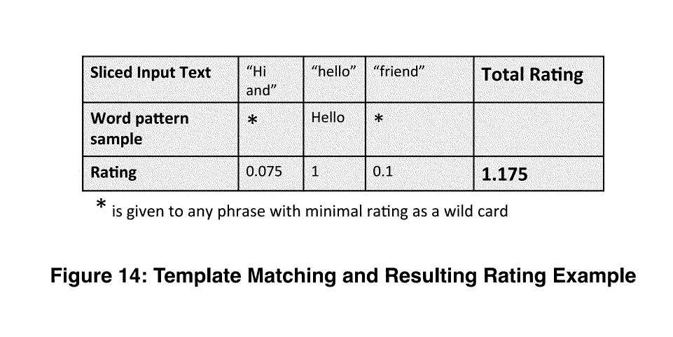

FIG. 14: Template Matching and Resulting Rating Example

FIG. 14 depicts how the phrase “Hi and hello friend” would be rated by VOiS using the word comparison with the word pattern sample method describe above, and then assigned both the partial and total ratings. Note that “*” (which is the standard wild card in regular expressions) is used here for words or phrases that could have very low ratings. Said another way, items associated with “*” could be removed without affecting the semantic meaning of the result and, hence, are of lower value.

FIG. 15: Templates Setup and Dialog Tree Search

FIG. 15 further illustrates the relationship between the templates and dialog search trees in the example of Engine 1.

Nested context structure used in the system provides support for long conversations. The system supports the maintenance of long conversations between user and a VOiS based product by combination of context (represented by dialog trees) retention, selecting and switching between multiple topics, and various processes of iteration.

Context (or topic) retention, selection and switching are supported by navigating up and down a set of dialog trees. Each interaction may match a node in a dialog tree. As mentioned above, in conventional systems, NLP typically proceeds by working from top down, attempting to match the pattern of a single dialog tree. FIG. 17 illustrates how VOiS based systems perform this process. Unlike conventional NLP systems, VOiS effectively searches multiple domain trees (essentially topics) in parallel, and can move both up and down those trees, and jump its focus from one domain sub-tree to another as the result of a sequence of interactions. The parallelism exists at least because the various hypotheses assigned at this step could be matched to different domain-sub trees. More specifically, VOiS implements a nested context architecture that functions as follows:

The VOiS System finds a matching topic in the users request by extracting the main semantic object. The system proceeds to then analyze the user's next request assuming that the analysis should stay in the topic of the previous one. For example if user asks “Who is Barack Obama,” the system will assume that Barack Obama is the topic of conversation and will try to answer the next request staying in this topic. If a user next asks: “How old is he?” then the system will understand the question to be on the same topic as in: “How old is Barack Obama?” The system will then attempt to answer via one of the NLP applications. To do so, the system maintains a list of contexts associated with prior user requests in the Dialog History 102. Because there is a list of responses and inputs, and these correspond well to previously encountered contexts and positions in the variously tracked domain sub-trees for each context, the system, in effect, provides responses that correspond to a nested set of contexts that are updated with each user interaction or other relevant data input in to the system (such as incoming data from an IoT device).

To pick the most relevant answer out of variety of options, the system analyzes some number of whole dialog sub-trees among those previously checked, and for each one, assigns a “bonus” to the rating. The Response Engine does not in and of itself select the response. Rather, it evaluates the relevance to the topics in the dialog trees and contributes a correspondingly weighted “bonus” to the total rating of each hypothesis. For example, to find the most relevant answer the system may check the previous 2 or more dialogs. Additionally, the system will changes context to the most appropriate previous topic and search in that dialog tree, and so on. So if user asked “Who is Barack Obama,” then asked about the weather or a news, and than asked “how old is he?” then system will still understand the question as “How old is Barack Obama?” And if between “Who is Barack Obama” and “how old is he?” the user asked about other person (for example “Who is William Shakespeare?”) then the system will ask the user a clarifying question. In this case such a question might be “Barack Obama or William Shakespeare?”

FIGS. 16 and 17 were discussed in conjunction with ratings adjustment above.

FIG. 18: Best Response Selection and Dialog History Update (Block 15)

The goal of this block is to select the best probabilistic response possible from all the outputs of all the participating Response Engines 14, illustrated as 68A, . . . 68B. In this exemplary case, a simple algorithm determining the maximum reported rating, executed by the Highest Rating Selection block 92, and producing the Best Response 93 is chosen as the response output. It is to be understood that additional filtering; using categorical weighting, or other best response selection scheme could be used. Also alternatively, multi-valued logic, or selection of a set of responses could be used if multiple valued outputs were desired from the NLP processing chain.

Additionally, and very importantly, this block also updates the Dialog History database 102 with the response and marks it as the current context. This Dialog History database 102 stores tuples of a request, its associated answer, and its relevance to a specific context, all with the system's short-term memory. The timeframe retained can be set by the user to reflect the length of conversational persistence he preferred. For example, a 15-minute window might be appropriate for routine daily tasks around the house. Other users, such as those with cognitive disabilities, may benefit from longer periods of continuity.

FIG. 19: Response Processing (Block 27)

Having obtained the response for the user, VOiS now needs to “package” it for human-like voice delivery or to generate an output to control another system or IoT device. That is, the goal of this block often is to construct a meaningful, natural, and occasionally entertaining sentence or sequence of sentences to deliver the response or report on a performed or to-be-performed action.

This goal involves a complex set of processing methods, some of which interact with the Dialog History database 116. In one embodiment, these blocks may comprise:

112 Equal-rating answers randomization+repetition minimization: In some situations there could be many good answers for one case. For example, when the user says “Hello,” VOiS could respond with “Hello,” “Hi,” or “Good day” and many other expressions. This block obtains a random answer from such a set, attempting to minimize repetition. Thus if VOiS already responded with “Hello,” next time 112 will pick something else.

113 Repetition detector: If VOiS had to respond again (twice) with the same exact answer, this block adds to the generated answer some additional text to highlight the fact that this question/request was already answered/executed. For example “It is snowing” will be replaced with “I already mentioned that it is snowing.”

114 Processing/generating responses requiring user answer (requires interaction with 116): This module supports responses that require an answer from the user. For example the system may mark or designate a response as a “strong question,” necessitating that the user answer this question. If the user responds with something that cannot be used as the answer for this question, VOiS will repeat the question. For example, if VOiS asks “Do you want to erase all data?,” and the user answers “I don't know,” VOiS may re-iterate with “You need to answer yes or no. Do you want to erase all data?”

115 Subroutine processing (requires interaction with 116): Some response processing steps benefit from special interfaces with the response engine. This particular step is similar to that using a response engine like for Engine 1, and controls links to alternative answers. With this processing step, a user can temporarily switch the context to another topic to fulfill some requirements and then, after achieving the necessary dialog and response in the switched context, be returned to the main thread of the current conversation. For example, if VOiS wanted to know a user's name, it would make a subroutine mark to go to the procedure that asks a user's name, requests confirmation, saves new data and then returns control to your dialog. To mark this, VOiS would program: “Oh . . . I don't know your name @TO SUB request user name,” where “request user name” is name of the subprogram for gathering names. This subprogram is written once and can be used in many cases.

117 In-line randomization processing (requires interaction with 116): This module can randomize the text slated to be the answer. In such an answer we can store a special text construction with synonyms. For example this construction “Hello {my friend/human/friend}! Means that this answer can be randomly converted to one of three strings: “Hello my friend!,” “Hello human!,” “Hello firend!”

118 Scripts processing: The present system supports the ability to insert programming language fragments that will be executed, and then substituted, and the result delivered to the user. Such scripts will be executed at this juncture and the result of the execution is inserted within the intended new answer text. For example if we need to create an answer to the question “Get me a random number,” VOiS would express this as: “I say [-random(100)-], where [- -] marks the script construction. When the script is processed, the string changes, for example, to “I say 42.” Any competent scripting language, such as JavaScipt can be used for scripting.

119 Unconditional jump processing (requires interaction with 116): This step might only be implemented in systems having a response engine similar to Engine 1. This module processes special marks to switch content to another template (and dialog context) as dictated by the Dialog History database 116.

120 Additive jump processing (requires interaction with 116): Similar to the foregoing, this step may only be appropriate for systems having at least one response engine like Engine 1, and works similarly to module 119, except that rather than merely switching the dialog context, it points to an answer that is a substitution within a current answer. For example, if VOiS has some answer with the word “random” that produces a random number, it will use an “additive jump” to produce: “Hello! @TO_ANS random,” to lead to the result: “Hello! I say 95.”

121 VOiS Utility commands processing (requires interaction with 116): This module processes OS commands in an answer's text that can control the dialog process. There are commands such as, for examples, to stop a dialog after the speech ends (@END command) and to clear the current context (@! Command). Also there are commands for functions related to device control. For examples, to switch a device's indicator color, to change the device's volume level, to turn the device on or off, etc.

122 Context update: After building the final version of the current answer/response, VOiS saves this final version to the Dialog History database 116 and closes this immediate “transaction.” VOiS then switches the context to a new position, posts the current answer to the user or IoT (or other) device or program, and saves it in 116 with the status “the last answer.” This action moves the current dialog pointer position to this answer.

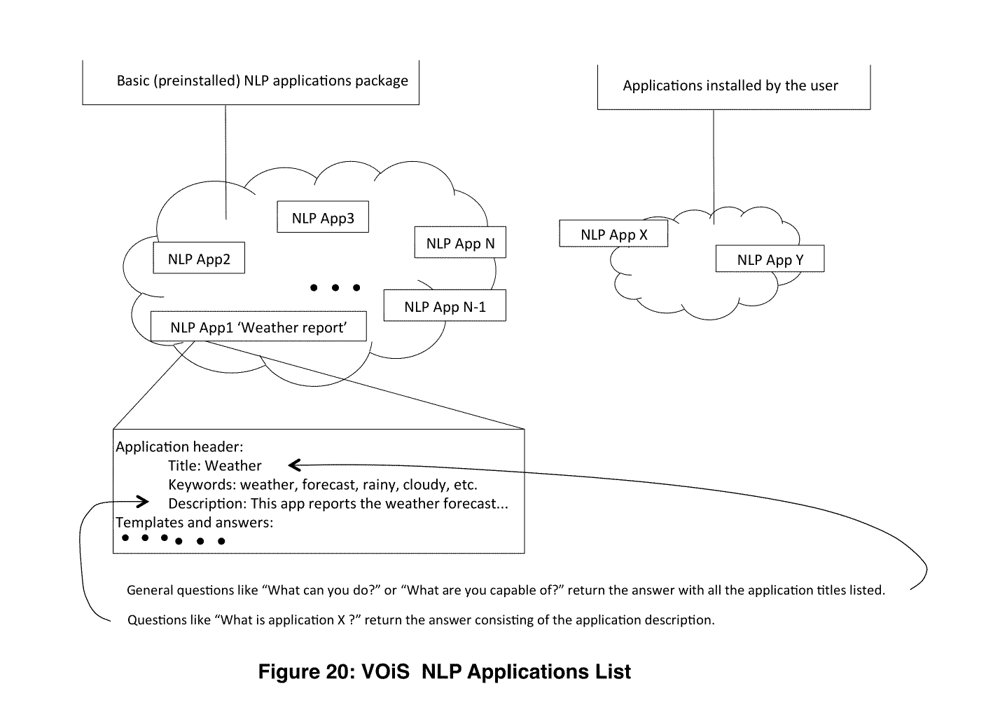

FIG. 20: VOiS NLP Applications List (block 5)

As is the case for a standard operating systems such as Linux, Windows, or MacOS (to name a few), there is a wealth of applications running on the operating system to provide functionality for the users. Applications tailored to VOiS and able to take advantage of the foregoing capabilities are called NLP Apps (see FIG. 5) running on top of VOiS. VOiS' NLP stack structure is a key enabler variable program because unlike all other inputs to an OS, entered as incoming data coded via various protocols, the input to such a stack is highly vague, imprecise, and full of entropy—it is natural human language, which varies not only from language to language, but also from culture to culture, and even on the granularity of variability from person to person.

NLP Apps could perform many functions, such as:
a. Calculator
b. Word games
c. Educational programs
d. Interaction with external devices (such as an internet-connected thermostat or GPS, or sensors from the smart grid or utility meter).

As described in FIG. 5, NLP Apps for VOiS can be developed on a special purpose NLP programming language. In the case of VOiS, one such language has been named Diacortex. Each NLP App, generally has a set of mandatory attributes, containing, at least, the “name,” the “synonyms,” and the “type.” In some NLP Apps we could also use additional attributes, such as “textual description”, “use examples”, etc.

A characteristic, but not limiting, set of attributes may be as follows:
a. Name—the unique program identifier.
b. Synonyms—the program name can have a set of synonyms. For example, the “news” program could also be equated to “news feed,” “news announcement,” “latest news.” Thus, based on these synonyms the user does not have to identify the specific program literally when he or she interacts with the system. Furthermore, developers could expand on the synonyms concept by generating a schema from other knowledge bases that would identify them all as a specific function or application to automatically be invoked by VOiS.
c. Textual description—program functionality description. This text is used when the user wants to get help information about the program or just talks about it.
d. Use cases—the program can contain a set of examples of the program's usage. This text is used for the answer generation when the user wants to know how to use the program.
e. Program type—this attribute describes situations that activate the program. Some programs are applicable under certain conditions or time of the day or for certain people only. For example, the “smart house” program can only be used in the house. So each program has its own set of activation parameters.

The program attributes are kept within the titles of the program file(s). The NLP App title is a special structure usually located in the beginning of the file containing service information. These are not strict rules however. NLP Apps could be implemented where attributes are stored in a database or have no attributes at all.

The foregoing attributes are illustrative only, and one versed in the art would understand that extensions along the same lines would be architecturally equivalent.

A special case of an NLP App is the emotional overlay. Since such emotional overlay apps would have many attributes in common, we will provide an open “Emotional Skin Template” which developers can fill out or change the attributes and get an “instantiated personality” up and running quickly. This could then be further refined via writing code in Diacortex, or via programming the emotional overlay via the Voice Programming App.

A user's options to manage NLP applications include, but are not limited to:
a. Access the VOiS based NLP App by performing one of the program's functions. VOiS will process the user's request and answer it using a specific application. The point is that the user does not have to think about the programs—rather merely request the function he or she requires to be executed.
b. Users can obtain a list of NLP Apps from VOiS by asking a specific question, such as, “what can you do for me?,” “what are your capabilities?,” etc. To answer a request of this kind, the system will line up the list of its NLP Apps and announce those to the user one by one.

VOiS could have a basic pre-installed set of NLP Apps. Additionally users could also add new NLP Apps by installing those on VOiS or developing them using the Diacortex programming language.

### DEFINITIONS

Unless otherwise explicitly recited herein, any reference to an electronic signal or an electromagnetic signal (or their equivalents) is to be understood as referring to a non-volatile electronic signal or a non-volatile electromagnetic signal.

Recording the results from an operation or data acquisition, such as for example, recording results at a particular frequency or wavelength, is understood to mean and is defined herein as writing output data in a non-transitory manner to a storage element, to a machine-readable storage medium, or to a storage device. Non-transitory machine-readable storage media that can be used in the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. Unless otherwise explicitly recited, any reference herein to “record” or “recording” is understood to refer to a non-transitory record or a non-transitory recording.

As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes. Recording image data for later use (e.g., writing an image to memory or to digital memory) can be performed to enable the use of the recorded information as output, as data for display to a user, or as data to be made available for later use. Such digital memory elements or chips can be standalone memory devices, or can be incorporated within a device of interest. “Writing output data” or “writing an image to memory” is defined herein as including writing transformed data to registers within a microcomputer.

General purpose programmable computers useful for controlling instrumentation, recording signals and analyzing signals or data according to the present description can be any of a personal computer (PC), a microprocessor based computer, a portable computer, or other type of processing device. The general purpose programmable computer typically comprises a central processing unit, a storage or memory unit that can record and read information and programs using machine-readable storage media, a communication terminal such as a wired communication device or a wireless communication device, an output device such as a display terminal, and an input device such as a keyboard. The display terminal can be a touch screen display, in which case it can function as both a display device and an input device. Different and/or additional input devices can be present such as a pointing device, such as a mouse or a joystick, and different or additional output devices can be present such as an enunciator, for example a speaker, a second display, or a printer. The computer can run any one of a variety of operating systems, such as for example, any one of several versions of Windows, or of MacOS, or of UNIX, or of Linux. Computational results obtained in the operation of the general purpose computer can be stored for later use, and/or can be displayed to a user. At the very least, each microprocessor-based general purpose computer has registers that store the results of each computational step within the microprocessor, which results are then commonly stored in cache memory for later use, so that the result can be displayed, recorded to a non-volatile memory, or used in further data processing or analysis.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein, so long as at least some of the implementation is performed in hardware.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

Any patent, patent application, patent application publication, journal article, book, published paper, or other publicly available material identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A method for managing and executing voice enabled computer applications comprising:
at an electronic device connected to a network,
receiving recognized text,
generating a set of input request hypotheses,
processing each of a set of input request hypotheses through one or more response engines to generate a set of possible responses,
selecting a best response from the set of possible responses,
processing the best response to update a dialog history, and
transmitting the best response over a network.

2. The method of claim 1 wherein the recognized text represents a user request or an Internet of Things request.

3. The method of claim 1 wherein the best response is a text response or an action response, wherein the action response is a command or query to an Internet of Things device or a command or query to a software application.

4. A method of processing natural language using a programmable electronic device comprising:
receiving a request,
deciphering the request,
generating a set of possible responses, and
ranking the appropriateness of the set of possible responses
wherein the ranking of each member of the set of possible responses is a function of a fuzzy logic match to a template,
selecting an ultimate response, from the set of possible responses, having a highest total rating.

5. The method of claim 4 wherein the deciphering a request comprises:
iteratively processing text against one or more linguistic databases to produce rated terms.

6. The method of claim 4 wherein the deciphering a request comprises:
iteratively applying domain specific functions to produce a set of rated expressions.

7. The method of claim 4 wherein the request comes from a human user or an Internet of Things device or software application.

8. The method of claim 4 wherein the response may be an answer to a human user in human language, or an action performed on a device or a software application.

9. The method of claim 4 wherein the ranking is computed by assigning positive and negative coefficients to a plurality of linguistic attributes which match each member of the set of possible responses.

10. The method of claim 4 wherein the total rating is based on a set of matching rules that each contributes a numerical weight to the total rating on a continuous scale.

11. The method of claim 4 wherein a context reference of pronouns in a request representing human user's speech is embedded into the total rating by giving those requests with closer contextual matches a higher contributing score to raise the total rating.

12. The method of claim 4 wherein a request representing utility commands is detected by a template match and contributes a high score to the total rating.

13. The method of claim 4 wherein an up-the-tree search of a dialog tree is used to find a matching dialog context and contributes a score to the total rating proportional to how well it matches the dialog contexts.

14. The method of claim 4 wherein the deciphering a request comprises generating a set of intent hypotheses as to what the intent of the request was where each intent hypothesis carries an associated rating.

15. The method of claim 14 wherein for each intent hypothesis:
generating a set of response hypotheses,
for each response hypothesis:
calculating a ranked response hypothesis,
associating the ranked response hypothesis with its intent hypothesis to form a response tuple,
generating a total rating for the response tuple.

16. The method of claim 15 wherein a response corresponding to a conversation with a human user contributes to the total rating in proportion to how closely the response matches a dialog context representing the conversation.

17. The method of claim 15 wherein a history of request and response tuples are stored, and the selection of a future response is a function of the history of stored request and response tuples.

18. A method comprising:
receiving input text,
generating a response by employing one or more of response engines, wherein each response engine generates a set of proposed responses and each proposed response is assigned a rating,
collecting the set of proposed responses from each one or more response engines into a superset of proposed responses, and
selecting the proposed response with the highest rating from the superset of proposed responses as a desired response.

19. The method of claim 18 wherein the one or more response engines execute in parallel.

20. The method of claim 18 wherein each of the one or more response engines has a specific and distinct goal.

21. The method of claim 18 wherein each of the one or more response engines comprises a different set of methods and data structures.

22. The method of claim 18 wherein the input text comes from a user or an Internet of Things device or software application.

23. The method of claim 18 wherein the desired response comprises an answer to a user in human language, or a command for action to be performed on a device or a software application.

24. The method of claim 18 wherein one or more of the one or more response engines follows a method comprising:
generating a set of response hypotheses by matching a rated expression against one or more templates wherein a response is conditionally added to the set of response hypotheses,
applying an adjustment to each of the response hypotheses to produce one or more rated responses.

25. The method of claim 24 wherein the matching a rated expression further comprises the use of fuzzy logic.

26. The method of claim 24 wherein the applying an adjustment comprises a context adjustment.

27. The method of claim 24 wherein the applying an adjustment comprises a dialog adjustment, and the dialog adjustment interacts with one or more dialog trees.

28. The method of claim 24 wherein the applying an adjustment comprises an adjustment to enable system level control or query.

29. A system comprising:
an electronic device,
means for the electronic device to receive input text,
means to generate a response
wherein the means to generate the response is a software architecture organized in the form of a stack of functional elements comprising:
an operating system kernel whose blocks and elements are dedicated to natural language processing,
a dedicated programming language specifically for developing programs to run on the operating system,
one or more natural language processing applications developed employing the dedicated programming language wherein the one or more natural language processing applications may run in parallel.

30. The system of claim 30 wherein the one or more natural language processing applications employ an emotional overlay.
